(19) United States
(12) Patent Application Publication
(10) Pub. No.: US 2011/0320500 A1
(43) Pub. Date: Dec. 29, 2011

(54) SYSTEM AND METHOD FOR CONSTRUCTING A UNIVERSITY MODEL GRAPH

(75) Inventors: Sridhar Varadarajan, Bangalore (IN); Srividya Gopalan, Bangalore (IN); Preethy Iyer, Bangalore (IN)

(73) Assignee: SRM INSTITUTE OF SCIENCE AND TECHNOLOGY, Chennai (IN)

(21) Appl. No.: 12/945,582

(22) Filed: Nov. 12, 2010

(30) Foreign Application Priority Data
Jun. 28, 2010 (IN) 1809/CHE/2010

(51) Int. Cl. G06F 17/30

(52) U.S. Cl. 707/798; 707/E17.011

(57) ABSTRACT

An educational institution (also referred as a university) is rich with multiple kinds of data: students, faculty members, departments, divisions, and at university level. Relating and correlating this data at and across various levels help in obtaining a perspective about the educational institution. A structural representation captures the essence of all of the relationships in a unified manner and an important aspect of the relationship is the so-called “influence factor.” This factor indicates influencing effect of an entity over another entity, wherein the entities are a part of the structural representation. A system and method for the construction of such a structural representation of an educational institution based on the educational institution specific information is discussed.

A reference is made to the applicants' earlier Indian patent application number 1269/CHE2010 filed on 6 May 2010.

### FIELD OF THE INVENTION

The present invention relates to the construction of a structural representation of a university in general, and more particularly, semi-automated construction of the structural representations. Still more particularly, the present invention relates to a system and method for semi-automatic construction of a model graph associated with a university.

### BACKGROUND OF THE INVENTION

An educational institution (also referred as university) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. In order to be able to assess the university in a manner for to be used for multiple purposes such as for prospective students, candidates exploring opportunities within the university, for the funding agencies, and for providing an objectivized assessment information for the university visitors, there is a need to construct a structural representation of the university based on the known information about the university. This constructed structural representation forms the basis for helping prospective students to have a better understanding of the university they are exploring to enroll and helping funding agencies to get a better picture of the university that they are planning to fund.

### DESCRIPTION OF RELATED ART

United States Patent Application 20090191527 titled “Systems and Methods for Assisting an Educational Institution in Rating a Constituent” by King; Melissa; (West Chester, Pa.); Mendonca; Denise Marie; (San Diego, Calif.); Packard; Patrick; (Hingham, Mass.); Reber; Martin Donald; (Coatesville, Pa.); Rullo; Robert David; (West Chester, Pa.) (filed on Feb. 6, 2008 and assigned to SunGard Higher Education Inc. Malvern, Pa.) describes a system for a graphical display of a probability and desirability value for a person at a stage of a student life cycle. For example, the higher education relationship system may receive a history of interactions between the person and the institution and may use these interactions and information about the person to calculate the measure of the likelihood that the person moves to another stage in the student life cycle, and the desirability value, or a measure of the appeal of the person to the educational institution at a stage of the student life cycle.

“The Governance and Performance of Research Universities: Evidence from Europe and the U.S.” by Aghion; Philippe, Dewatripont; Mathias Dewatripont, Hoxby; Caroline, Mas-Colell; Andreu, and Sapir; André (Working Paper 14851, NBER Working Paper Series, National Bureau of Economic Research, Cambridge, Mass. 02138, April 2009) describes how university governance affects research output, measured by patenting and international university research rankings

“A model of assessment in higher education institutions” by Joughin; Gordon and Macdonald; Ranald (Article, The Higher Education Academy, 2004) describes a model of the complex phenomenon of assessment in higher education based on four principle levels.

“Academic Institution Internal Structure Ontology (AIISO)” from the website url “http://vocab.org/aiiso/schema ” (with the latest version available at “http://purl.org/vocab/aiiso/schema#” (accessed on 17-May-2010), May 2008) provides classes and properties to describe the internal organizational structure of an academic institution.

“Decision Support System for ManagingEducational Capacity Utilization in Universities” by Vinnik; Svetlana and Scholl; Marc (appeared in the Proceedings of International Conference on Engineering and Computer Education (ICECE'05), Madrid, Spain from Nov. 13-Nov. 16, 2005) describes a methodology for assessing educational capacity and planning its distribution and utilization in universities.

The known systems do not address the issue of a comprehensive modeling of an educational institution at various levels in order to be able to assess the educational institution at various levels. The present invention provides for system and method for a comprehensive modeling of the educational institution at multiple levels based on a set of entities and the mutual influences among these entities.

### SUMMARY OF THE INVENTION

The primary objective of the invention is to model an educational institution in a comprehensive manner for helping in the assessment of the educational institution at elemental and component levels.

One aspects of the present invention is to construct a university model graph of an educational institute that provides the structural representation of the educational institution.

Another aspect of the invention is to model an entity of the educational institution using a defined parametric model.

Yet another aspect of invention is to model an entity of the educational institution using a defined hierarchical model.

Another aspect of the invention is to model an entity of the educational institution using a defined activity based model.

Yet another aspect of the invention is to model the educational institution using a list of positive influencers related to a pair of entities of the educational institution.

Another aspect of the invention is to model the educational institution using a list of negative influencers related to a pair of entities of the educational institution.

Yet another aspect of the invention is to assess an entity and the instances of the entity using a plurality of models associated with the entity of the educational institution.

Another aspect of the invention is to compute the mutual influences between an instance of an entity and another instance of another entity of the educational institution.

Yet another aspect of the invention is to compute the mutual influences between a pair of entities of the educational institution.

Another aspect of the invention is to compute the mutual influences between an instance of an entity and another entity of the educational institution.

Yet another aspect of the invention is to compute the mutual influences between an entity and an instance of another entity of the educational institution.

Yet another aspect of the invention is to construct a university model graph based on entity assessments, entity instance assessments, and mutual influences between (a) a pair of entity instances, (b) a pair of entities, (c) an instance of an entity and another entity; and (d) an entity and an instance of another entity.

In a preferred embodiment of the present invention provides a system for the construction of a university model graph of a university based on a plurality of assessments and a plurality of influence values to assist in the assessment of said university at multiple levels using a university database, a university knowledgebase, a plurality of models and a plurality of influencers, wherein

said university comprises of a plurality of entities and a plurality of entity-instances, wherein

each of said plurality of entity-instances is an instance of an entity of said plurality of entities, and

said university model graph comprises of a plurality of abstract nodes, a plurality of nodes, a plurality of abstract edges, a plurality of semi-abstract edges, and a plurality of edges,

with each abstract node of said plurality of abstract nodes corresponding to an entity of said plurality of entities,

each node of said plurality of nodes corresponding to an entity-instance of said plurality of entity-instances, and

each abstract node of said plurality of abstract nodes is associated with a model of said plurality of models, and

a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,

a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;

a source node of said plurality of nodes is connected to a destination node of said plurality of nodes by a directed edge of said plurality of edges and said directed edge is associated with an influence value of said plurality influence values, wherein said influence value is a value between −1 and +1;

a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said influence value is a value between −1 and +1; and

a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said influence value is a value between −1 and +1,

said system comprising:
means for obtaining of said plurality of models, wherein said plurality of models comprises a plurality of parametric models, a plurality of hierarchical models, and a plurality of activity based models;
means obtaining of said plurality of influencers associated with a pair of entities wherein each of said pair of entities is a part of said plurality of entities;
means for computing of an entity-instance assessment of said plurality of assessments, wherein said entity-instance assessment is associated with an entity-instance of said plurality of entity-instances;
means for assigning of said entity-instance assessment to an entity-instance node of said plurality of nodes, wherein said entity-instance node is associated with said entity-instance; (assignments are part of the sub-claims)
   means for computing of an entity assessment of said plurality of assessments, wherein said entity assessment is associated with an entity of said plurality of entities;
means for assigning of said entity assessment to an entity abstract node of said plurality of abstract nodes, wherein said entity abstract node is associated with said entity;
means for computing of an influence value, of said plurality of influence values, associated with a source entity-instance and a destination entity-instance, wherein said source entity-instance is a part of said plurality of entity-instances and said destination entity-instance is a part of said plurality of entity-instances;
means for assigning of said influence value to a directed link, of said plurality of links, from a source node of said plurality of nodes to a destination node of said plurality of nodes, wherein said source node is associated with said source entity-instance and said destination node is associated with said destination entity-instance;
means for computing of an entity influence value, of said plurality of influence values, associated with a source entity and a destination entity, wherein said source entity is a part of said plurality of entities and said destination entity is a part of said plurality of entities;
means for assigning of said entity influence value to a directed abstract link, of said plurality of abstract links, from a source abstract node of said plurality abstract nodes to a destination abstract node of said plurality of abstract nodes, wherein said source abstract node is associated with said source entity and said destination abstract node is associated with said destination entity;
means for computing of an entity-instance-entity-influence value, of said plurality of influence values, associated with a source entity-instance and a destination entity, wherein said source entity-instance is a part of said plurality of entity-instances and said destination entity is a part of said plurality of entities;
means for assigning of said entity-instance-entity-influence value to a directed semi-abstract link, of said plurality of semi-abstract links, from a source node of said plurality of nodes to a destination abstract node of said plurality of abstract nodes, wherein said source node is associated with said source entity-instance and said destination abstract node is associated with said destination entity;
means for computing of an entity-entity-instance-influence value, of said plurality of influence values, associated with a source entity and a destination entity-instance, wherein said source entity is a part of said plurality of entities and said destination entity-instance is a part of said plurality of entity-instances; and
means for assigning of said entity-entity-instance-influence value to a directed semi-abstract link, of said plurality of semi-abstract links, from a source abstract node of said plurality of abstract nodes to a destination node of said plurality of nodes, wherein said source abstract node is associated with said source entity and said destination node is associated with said destination entity-instance.

### BRIEF DESCRIPTION OF THE DRAWINGS

FIG. 1 depicts an overview of UMG Construction System.

FIG. 1a depicts a partial list of entities of a University.

FIG. 1b depicts an illustrative University Model Graph.

FIG. 1c provides a University Model Graph Construction Matrix.

FIG. 1d provides the elements of a University Model Graph.

FIG. 2 describes the notions of Entity Assessment.

FIG. 2a describes the notations related to Entity Assessment.

FIG. 3 describes approaches for Entity Assessment.

FIG. 3a provides additional information about approaches for Entity Assessment.

FIG. 4 describes Entity-Instance Assessment Computation.

FIG. 4a provides additional information about Entity-Instance Assessment Computation.

FIG. 4b depicts Entity Assessment Computation.

FIG. 5 depicts an illustrative Entity and Entity-Instance Assessment Models.

FIG. 5a depicts additional illustrative Entity and Entity-Instance Assessment Models.

FIG. 5b depicts additional illustrative Entity and Entity-Instance Assessment Models.

FIG. 6 depicts an illustrative Entity-Instance Assessment.

FIG. 6a depicts an illustrative Entity Assessment.

FIG. 6b depicts an illustrative Entity Assessment based on Hierarchical Modeling.

FIG. 6c depicts an illustrative Entity-Instance Assessment based on Activity based Modeling.

FIG. 7 describes the aspects of I-Value Computation.

FIG. 7a provides additional information about the aspects of I-Value Computation.

FIG. 8 describes a system for UMG Construction.

FIG. 8a describes a sub-system for I-Value Computation.

FIG. 8b describes an approach for I-Value Computation.

FIG. 8c depicts an illustration of EI-Value, IEEI-Value, and EIEI-Value Computations.

FIG. 8d depicts an approach for EI-Value, IEEI-Value, and EIEI-Value Computations.

FIG. 9 provides an illustrative LoPI related to STUDENT and FACULTY MEMBER.

FIG. 9a provides an illustrative LoNI related to STUDENT and FACULTY MEMBER.

FIG. 9b provides an illustrative LCOT related to STUDENT and FACULTY MEMBER.

FIG. 9c provides an illustrative Computation of II-Array related to FM Instance.

FIG. 9d provides an illustrative Computation of AI0 related to FM Instance.

FIG. 9e provides an illustrative Computation of II-Value 2 related to FM Instance.

FIG. 9f provides an illustrative Computation of I-Value related to FM Instance.

FIG. 9g provides an illustrative Depiction of I-Value related to FM Instance.

FIG. 9h provides an illustrative Computation of EI-Value, IEEI-Value, and EIEI-Value related to FM and S.

FIG. 9i provides an illustrative Depiction of EI-Value related to FM and S. FIG. 9J provides the summary of Four Influence Values related to FM and S.

### DETAILED DESCRIPTION OF THE PREFERRED EMBODIMENTS

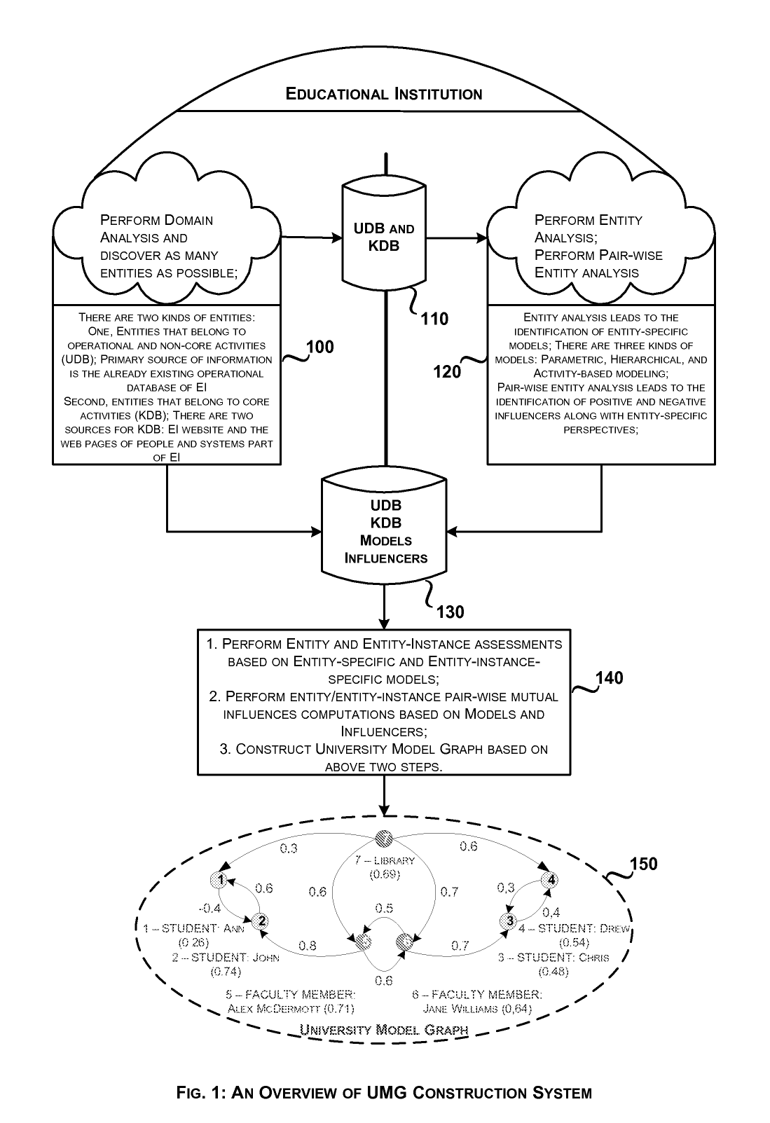

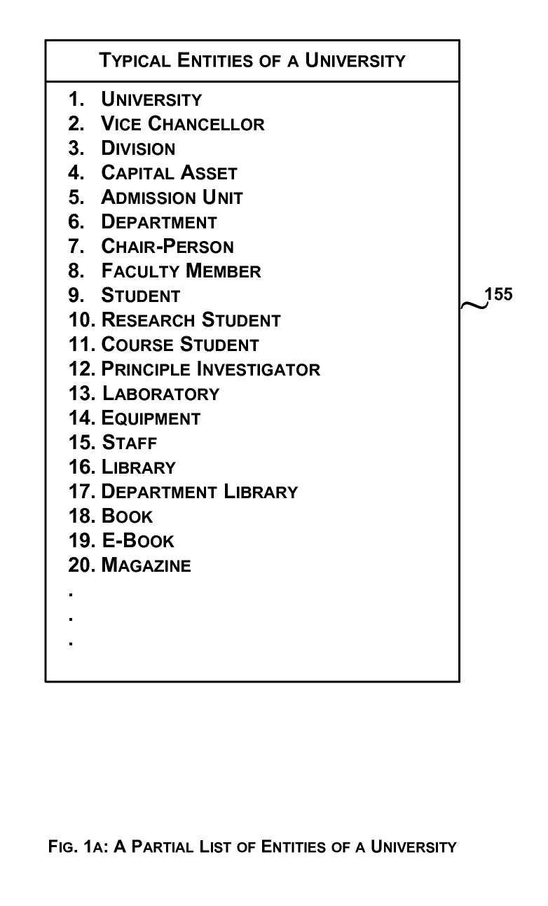

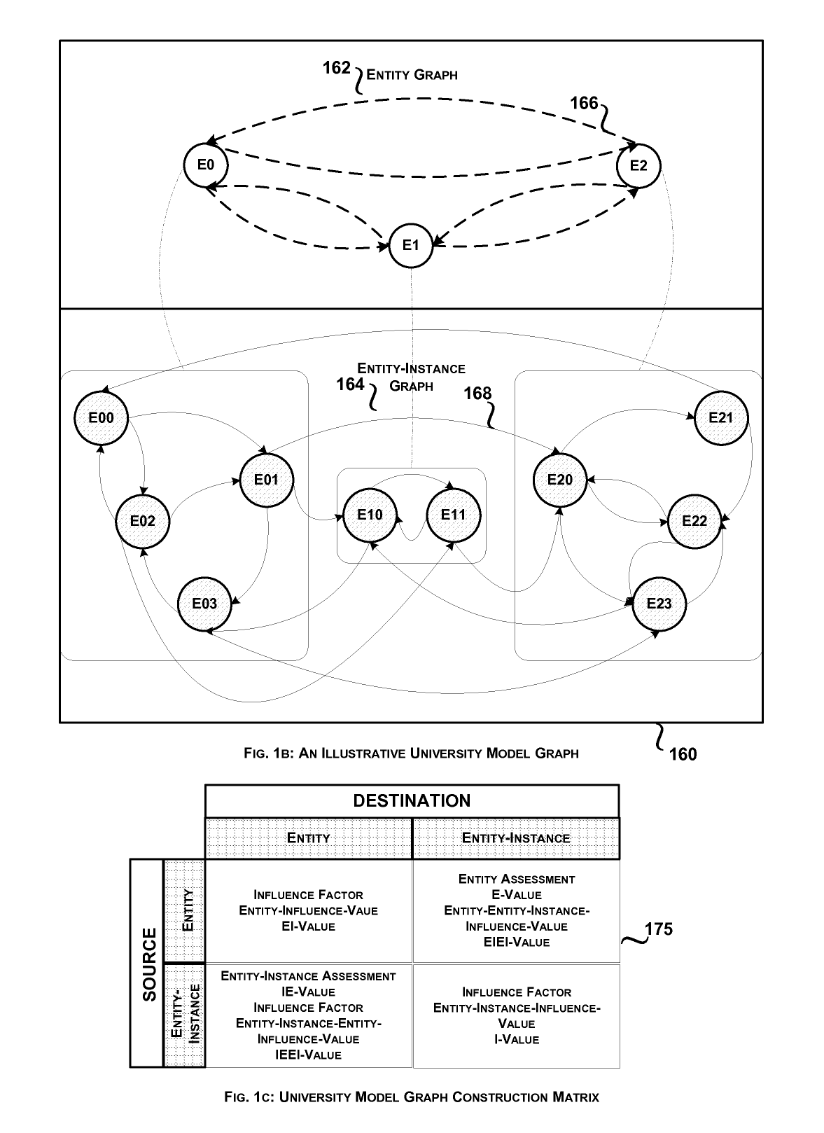

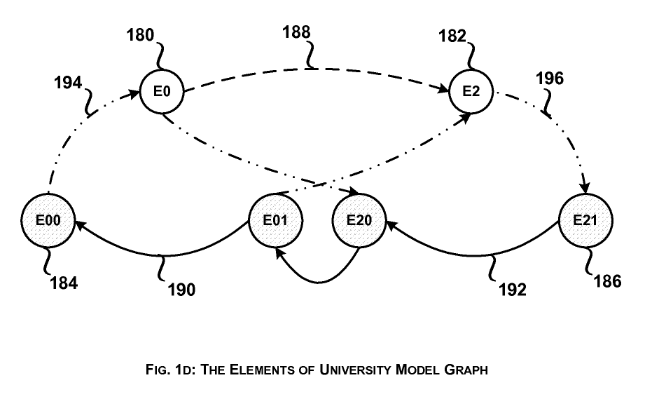

FIG. 1 depicts an overview of UMG Construction System. The Universal Model Graph of an educational institution (or equivalently, a university) is a structural representation of the information about the educational institution and helps in the assessment of the educational institution at various levels. An important aspect of the assessment is the identification of the entities of interest of the educational institution. There are two kinds of entities:

One, Entities that belong to operational and non-core activities (UDB); Primary source of information is the already existing operational database of EI; and

Second, entities that belong to core activities (KDB); There are two sources for KDB: EI website and the web pages of people and systems part of EI.

Perform Domain Analysis and discover as many entities as possible (100) and this results in the updated UDB and KDB (110).

In the next step, Perform Entity Analysis; and Perform Pair-wise Entity analysis (120).

Entity analysis leads to the identification of entity-specific models; There are three kinds of models: Parametric, Hierarchical, and Activity-based modeling;

Pair-wise entity analysis leads to the identification of positive and negative influencers along with entity-specific perspectives.

This leads to the updated databases (130).

The major steps involved in the process of UMG construction are as follows (140):

1. Perform Entity and Entity-Instance assessments based on Entity-specific and Entity-instance-specific models;

2. Perform entity/entity-instance pair-wise mutual influences computations based on Models and Influencers; and

3. Construct University Model Graph based on above two steps.

An illustrative UMG is depicted in 150. The nodes 1, 2, 3, and 4 are instances of STUDENT entity and the numerical value (<1) indicates the entity-instance assessment. For example, the assessment of John Abraham is 0.74. Similarly, the other nodes also stand for entity instances: nodes 5 and 6 are instances of the entity FACULTY MEMBER while node 7 is an instance of entity LIBRARY. Note that if there is only one entity instance for an entity (say, LIBRARY), then the entity and the entity instance are used interchangeably. The directed edges (or equivalently, links) depict the nature and quantum of influences: for example, the directed edge (link) from node 5 to node 2 indicates a positive influence of 0.8 by the faculty member Alex McDermott on the student John Abraham.

FIG. 1a depicts a partial list of entities of a University. Some of the critical entities include UNIVERSITY, FACULTY MEMBER, STUDENT, and LIBRARY (155).

FIG. 1b depicts an illustrative University Model Graph. 160 describes UMG as consisting of two main components: Entity Graph (162) and Entity-Instance Graph (164). Entity graph consists of entities of the university as its nodes and an abstract edge (166) or abstract link is a directed edge that connects two entities of the entity graph. The weight associated with this abstract edge is the influence factor or influence value indicating nature and quantum of influence of the source entity on the destination entity. Similarly, the nodes in the entity-instance graph are the entity instances and the edge (168) or the link between two entity-instances is a directed edge and the weight associated with the edge indicates the nature and quantum of influence of the source entity-instance on the destination entity-instance.

FIG. 1c provides a University Model Graph Construction Matrix. 175 shows the various elements of the matrix. The rows are labeled as Entity and Entity-Instance, and the columns are also similarly labeled. The element corresponding to Source Entity-Destination Entity indicates the influence factor or influence value (EI-Value) associated with Source Entity with respect to Destination Entity. That is, EI-Value indicates how a source entity influences a destination entity Similarly, the element Source Entity-Instance-Destination Entity-Instance indicates the influence factor or value (I-Value) associated with Source Entity-Instance with respect to Destination Entity-Instance. That is, I-Value indicates how a source entity instance influences a destination entity instance. The element related to Entity-Instance and Entity indicates the influence factor or value (IEEI-Value) associated with the Source Entity-Instance with respect to Destination Entity. Finally, the element related to Entity and Entity-Instance indicates the influence factor or value (EIEI-Value) associated with the Source Entity with respect to Destination Entity-Instance. Further, these two elements also indicate the Entity assessment (E-Value) and the Entity-Instance assessment (IE-Value). Thus two assessments and four influence factors or values form the most significant ingredients of the university model graph.

FIG. 1d provides the elements of a University Model Graph. The fundamental elements are nodes and edges. There are two kinds of nodes: Abstract nodes (180 and 182) and Nodes (184 and 186); There are three kinds of directed edges or links: Abstract links (188), links (190 and 192), and semi-abstract links (194 and 196). As part of the modeling, the abstract nodes are mapped onto entities and nodes are mapped onto the instances of the entities; an abstract link corresponds to an EI-Value, a semi-abstract link corresponds to either an EIEI-Value or an IEEI-Value, and finally, a link corresponds to an I-Value. Note that edges and links are used interchangeably. Further, each entity is associated with a model and an instance of an entity is associated with a base score and an instantiated model, wherein the base score is computed based on the associated instantiated model.

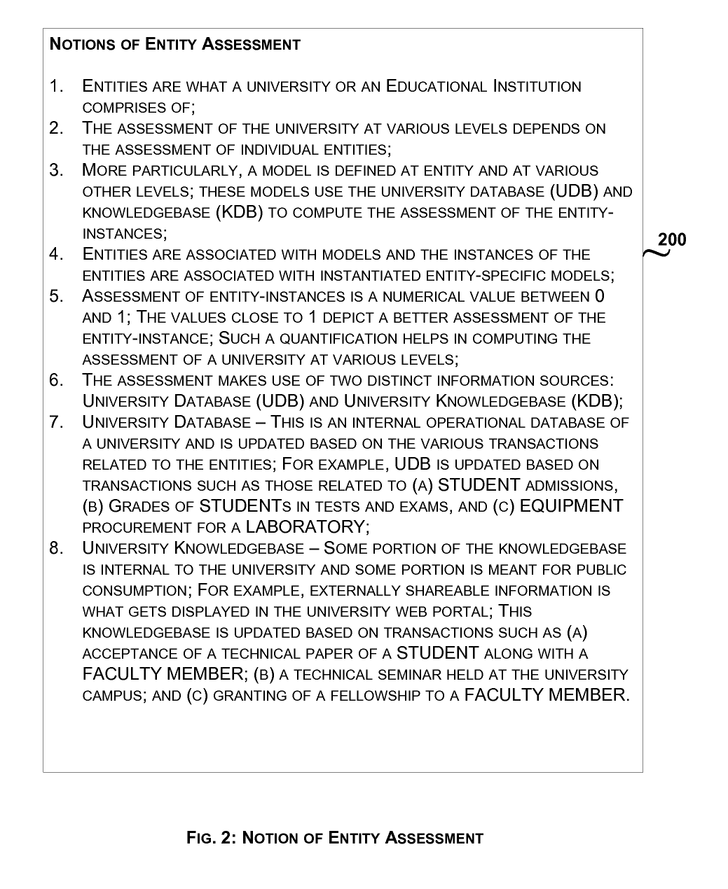

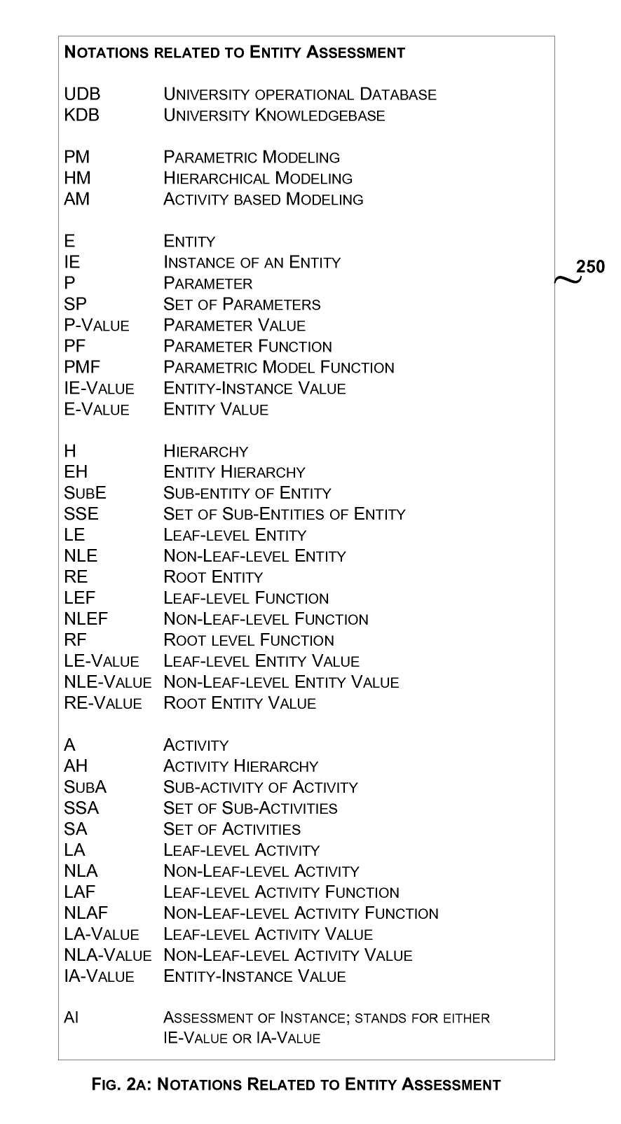

FIG. 2 describes the notions of Entity Assessment. Notions of Entity Assessment (200):

1. Entities are what a university or an Educational Institution comprises of;

2. The assessment of the university at various levels depends on the assessment of individual entities;

3. More particularly, a model is defined at entity and at various other levels; these models use the university database (UDB) and knowledgebase (KDB) to compute the assessment of the entity-instances;

4. Entities are associated with models and the instances of the entities are associated with instantiated entity-specific models;

5. Assessment of entity-instances is a numerical value between 0 and 1; The values close to 1 depict a better assessment of the entity-instance; Such a quantification helps in computing the assessment of a university at various levels;

6. The assessment makes use of two distinct information sources: University Database (UDB) and University Knowledgebase (KDB);

7. University Database—This is an internal operational database of a university and is updated based on the various transactions related to the entities; For example, UDB is updated based on transactions such as those related to (a) STUDENT admissions, (b) Grades of STUDENTs in tests and exams, and (c) EQUIPMENT procurement for a LABORATORY;

8. University Knowledgebase—Some portion of the knowledgebase is internal to the university and some portion is meant for public consumption; For example, externally shareable information is what gets displayed in the university web portal; This knowledgebase is updated based on transactions such as (a) acceptance of a technical paper of a STUDENT along with a FACULTY MEMBER; (b) a technical seminar held at the university campus; and (c) granting of a fellowship to a FACULTY MEMBER.

FIG. 2a describes the notations related to Entity Assessment.

Notations Related to Entity Assessment (250):

UDB University operational Database

KDB University Knowledgebase

PM Parametric Modeling

HM Hierarchical Modeling

AM Activity based Modeling

E Entity

IE Instance of an Entity

P Parameter

SP Set of Parameters

P-Value Parameter Value

PF Parameter Function

PMF Parametric Model Function

IE-Value Entity-Instance Value

E-Value Entity Value

H Hierarchy

EH Entity Hierarchy

SubE Sub-entity of Entity

SSE Set of Sub-Entities of Entity

LE Leaf-level Entity

NLE Non-Leaf-level Entity

RE Root Entity

LEF Leaf-level Function

NLEF Non-Leaf-level Function

RF Root level Function

LE-Value Leaf-level Entity Value

NLE-Value Non-Leaf-level Entity Value

RE-Value Root Entity Value

A Activity

AH Activity Hierarchy

SubA Sub-activity of Activity

SSA Set of Sub-Activities

SA Set of Activities

LA Leaf-level Activity

NLA Non-Leaf-level Activity

LAF Leaf-level Activity Function

NLAF Non-Leaf-level Activity Function

LA-Value Leaf-level Activity Value

NLA-Value Non-Leaf-level Activity Value

IA-Value Entity-Instance Value

AI Assessment of Instance; stands for either IE-Value or IA-Value

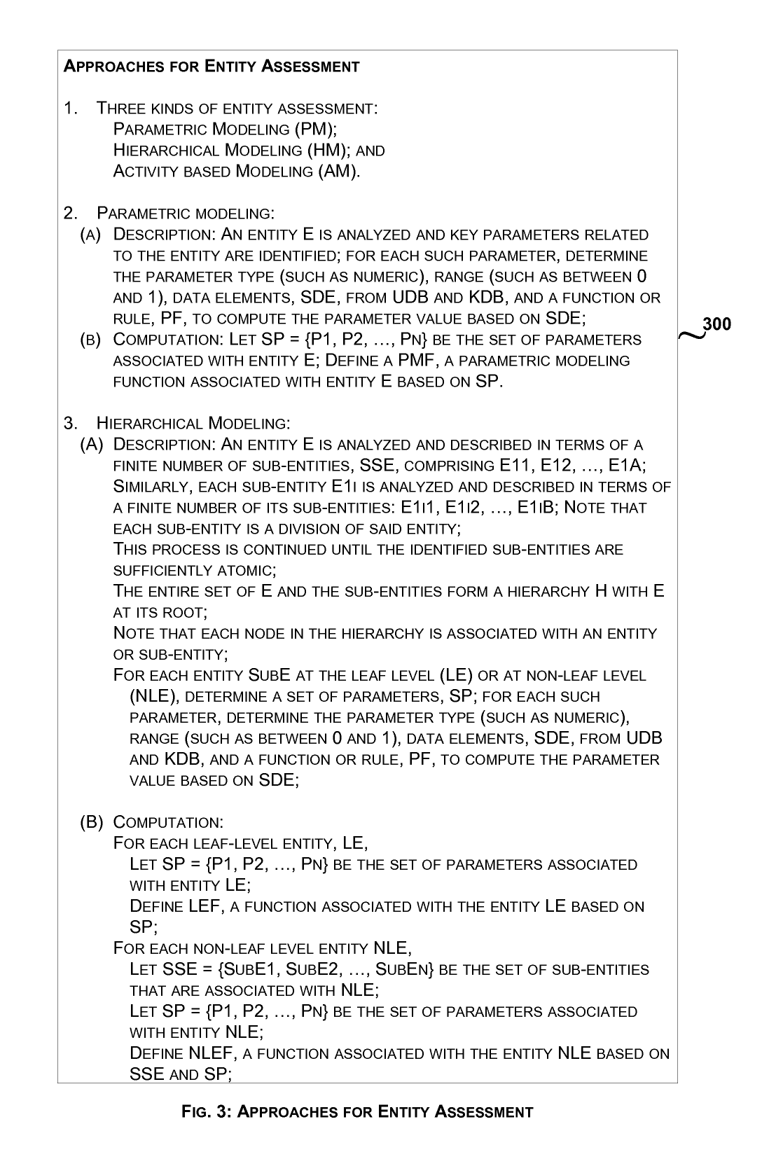

FIG. 3 describes approaches for Entity Assessment.

Approaches for Entity Assessment (300):

1. Three kinds of entity assessment based on the means for obtaining the various models:
Parametric Modeling (PM);
Hierarchical Modeling (HM); and
Activity based Modeling (AM).

2. Parametric modeling—elaborating the means for obtaining of parametric models:
(a) Description: An entity E is analyzed and key parameters related to the entity are identified; for each such parameter, determine the parameter type (such as numeric), range (such as between 0 and 1), data elements, SDE, from UDB and KDB, and a function or rule, PF, to compute the parameter value based on SDE;
(b) Computation: Let SP={P1, P2, . . . , Pn} be the set of parameters associated with entity E;
Define a PMF, a parametric modeling function associated with entity E based on SP.

3. Hierarchical Modeling—elaborating the means for obtaining of hierarchical models:
(A) Description: An entity E is analyzed and described in terms of a finite number of sub-entities, SSE, comprising E11, E12, . . . , E1A; Note that each sub-entity is a division of said entity;
Similarly, each sub-entity E1i is analyzed and described in terms of a finite number of its sub-entities: E1i1, E1i2, . . . , E1iB;
This process is continued until the identified sub-entities are sufficiently atomic;
The entire set of E and the sub-entities form a hierarchy H with E at its root;
Note that each node in the hierarchy is associated with an entity or sub-entity;
For each entity SubE at the leaf level (LE) or at non-leaf level (NLE),
Determine a set of parameters, SP;
For each such parameter, determine the parameter type (such as numeric), range (such as between 0 and 1), data elements, SDE, from UDB and KDB, and a function or rule, PF, to compute the parameter value based on SDE;
(B) Computation: For each leaf-level entity, LE,
   Let SP={P1, P2, . . . , Pn} be the set of parameters associated with entity LE;
   Define LEF, a function associated with the entity LE based on SP;
   For each non-leaf level entity NLE,
   Let SSE={SubE1, SubE2, . . . , SubEn} be the set of sub-entities that are associated with NLE;
   Let SP={P1, P2, . . . , Pn} be the set of parameters associated with entity NLE;
   Define NLEF, a function associated with the entity NLE based on SSE and SP;

FIG. 3a provides additional information about approaches for Entity Assessment.

Approaches for Entity Assessment (Contd.) (350)

4. Activity based Modeling—elaborating the means for obtaining of activity based models:
(A) Description: An entity E is analyzed and described in terms a set of activities, SA, such that the activities are relevant with respect to E;
Let SA={A1, A2, . . . , An} be a set of such activities;
For each activity Ai, perform one of the following:
(A1) Analyze and determine a set of parameters, SP={P1, P2, . . . , Pn} associated with Ai;
For each parameter Pi of SP, determine parameter type, range of values, data elements, SDE, of UDB and KDB, and a function or rule, PF, to determine the parameter value based on SDE;
(A2) Analyze and determine a set of sub-activities, SSA={Ai1, Ai2, . . . , Aib}. Note that each sub-activity is a division of the activity Ai and can be an atomic entity;
Further, Analyze and determine a set of parameters, SP={P1, P2, . . . , Pn} associated with Ai;
For each parameter Pi of SP, determine parameter type, range of values, data elements, SDE, of UDB and KDB, and a function or rule, PF, to determine the parameter value based on SDE;
(B) Computation: For each leaf-level activity, Sub-A,
Let SP={P1, P2, . . . , Pn} be the set of parameters associated with entity Sub-A;
Define LEF, a function associated with the activity Sub-A based on SP
For each non-leaf level activity Sub-A, Let SSA={SA1, SA2, . . . ,SAn} be the set of sub-activities that are associated with Sub-A;
Let SP={P1, P2, . . . , Pn} be the set of parameters associated with activity Sub-A;
Define PF, a function associated with the activity Sub-A based on SSA and SP;

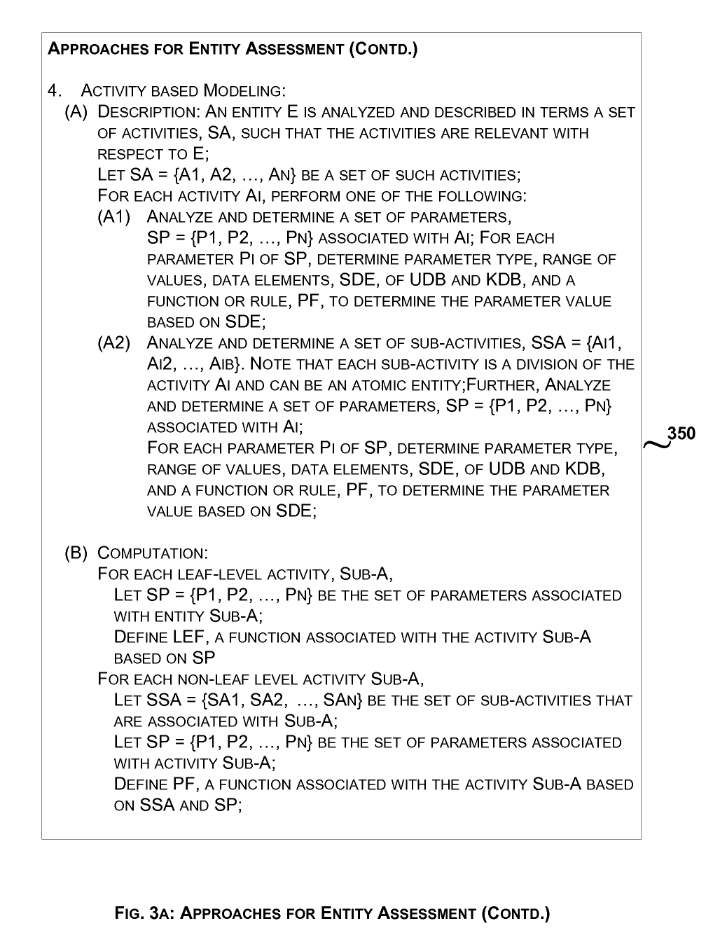

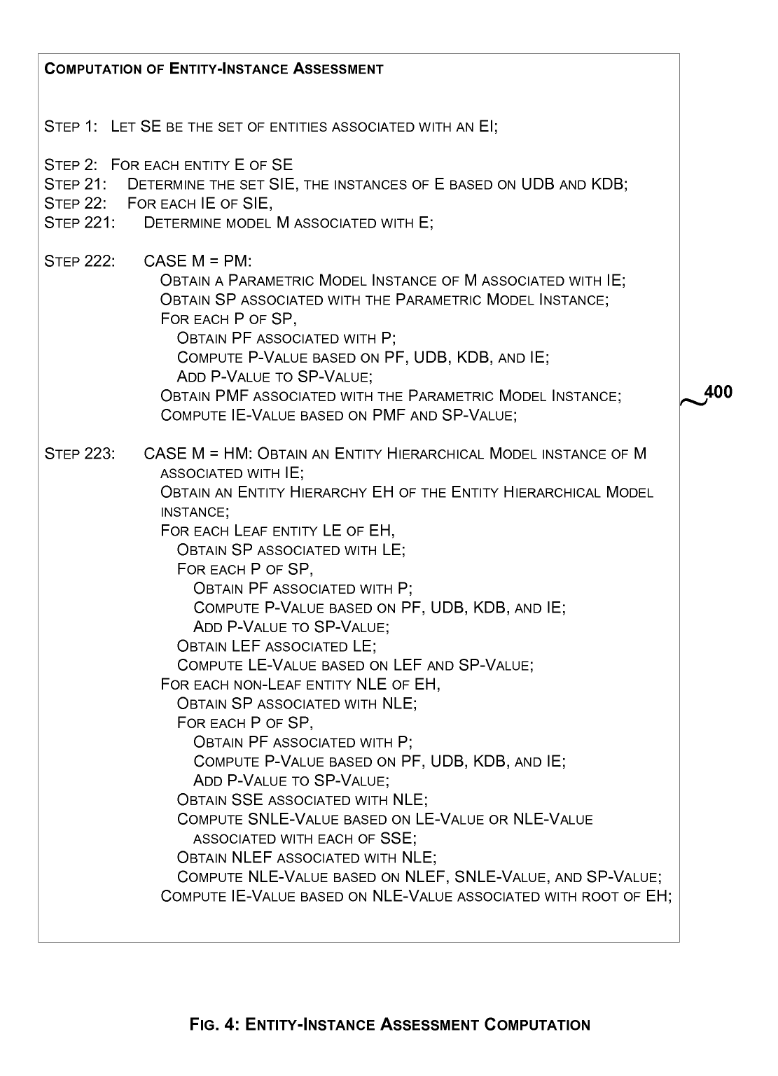

FIG. 4 describes Entity-Instance Assessment Computation.

Means for Computation of Entity-Instance Assessment (400):

Step 1: Let SE be the set of entities associated with an EI;

Step 2: For each entity E of SE

Step 21: Determine the set SIE, the instances of E based on UDB and KDB;

Step 22: For each IE of SIE,

Step 221: Determine model M associated with E;

Step 222: CASE M=PM:
Obtain a parametric model instance of M associated with IE;
Obtain SP associated with the parametric model instance;
For each P of SP,
Obtain PF associated with P;
Compute P-Value based on PF, UDB, KDB, and IE;
Add P-Value to SP-Value;
Obtain PMF associated with the parametric model instance;
Compute IE-Value based on PMF and SP-Value;

Step 223: CASE M=HM:
Obtain an Entity Hierarchical Model instance of M associated with IE;
Obtain Entity Hierarchy EH of the Entity Hierarchical Model instance;
For each Leaf entity LE of EH,
Obtain SP associated with LE;
For each P of SP,
Obtain PF associated with P;
Compute P-Value based on PF, UDB, KDB, and IE;
Add P-Value to SP-Value;
Obtain LEF associated LE;
Compute LE-Value based on LEF and SP-Value;
For each non-Leaf entity NLE of EH,
Obtain SP associated with NLE;
For each P of SP,
Obtain PF associated with P;
Compute P-Value based on PF, UDB, KDB, and IE;
Add P-Value to SP-Value;
Obtain SSE associated with NLE;
Compute SNLE-Value based on LE-Value or NLE-Value associated with each of SSE;
Obtain NLEF associated with NLE;
Compute NLE-Value based on NLEF, SNLE-Value, and SP-Value;
Compute IE-Value based on NLE-Value associated with root of EH;

FIG. 4a provides additional information about Entity-Instance Assessment Computation.

Means for Computation of Entity-Instance Assessment (Contd.) (450):

Step 224: CASE M=AM:
Obtain an Activity Hierarchical Model instance of M associated with IE;
Obtain Activity Hierarchy AH of the Activity Hierarchical Model instance;
For each Leaf Activity LA of AH,
Obtain SP associated with LA;
For each P of SP,
Obtain PF associated with P;
Compute P-Value based on PF, UDB, KDB, and IE;
Add P-Value to SP-Value;
Obtain LAF associated LA;
Compute IA-Value based on LAF and SP-Value;
For each non-Leaf Activity NLA of AH,
Obtain SP associated with NLA;
For each P of SP,
Obtain PF associated with P;
Compute P-Value based on PF, UDB, KDB, and IE;
Add P-Value to SP-Value;
Obtain SSA associated with NLA;
Compute SNLA-Value based on LA-Value or NLA-Value associated with each of SSA;
Obtain NLAF associated with NLA;
Compute NLA-Value based on NLAF, SNLA-Value, and SP-Value;
Compute IA-Value based on NLA-Value associated with root of AH;

Step 3: END.

FIG. 4b depicts Entity Assessment Computation.

Means for Computation of Entity Assessment (470):

Step 1: Let SE be the set of entities associated with an EI;

Step 2: For each entity E of SE

Step 21: Determine the set SIE, the instances of E based on UDB and KDB;

Step 22: Determine SIE-Value, a set of IE-Values based on SIE;

Step 23: Determine E-Value based on SIE-Value;

Step 3: END.

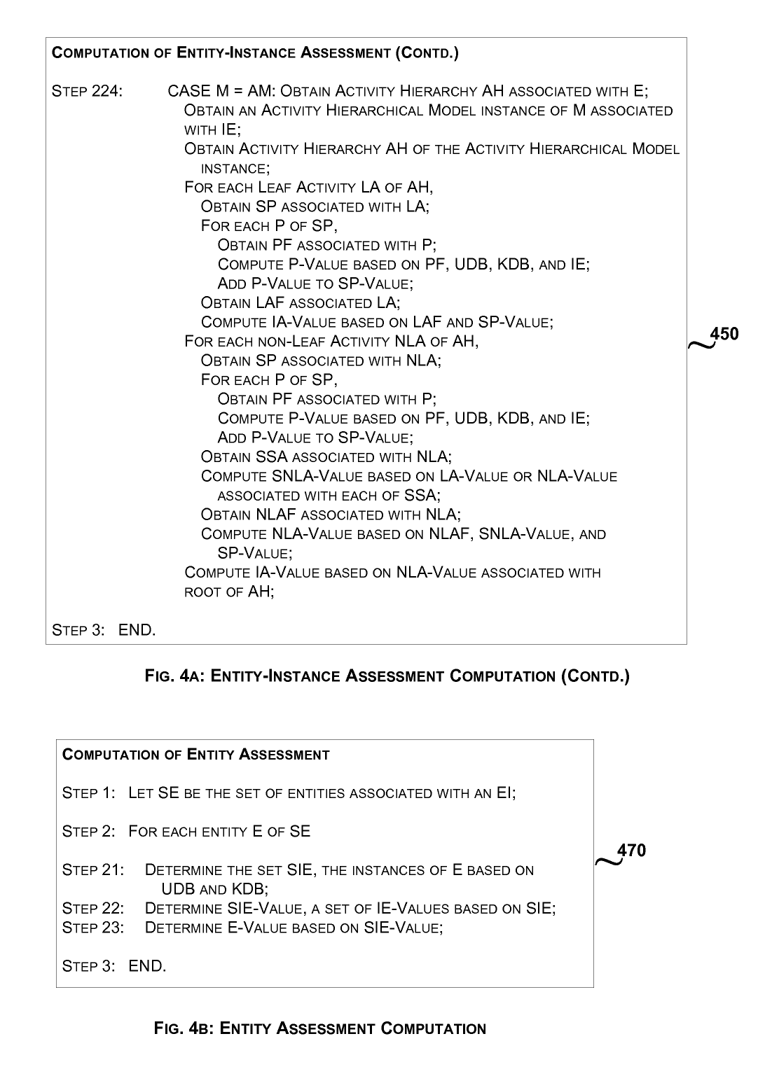

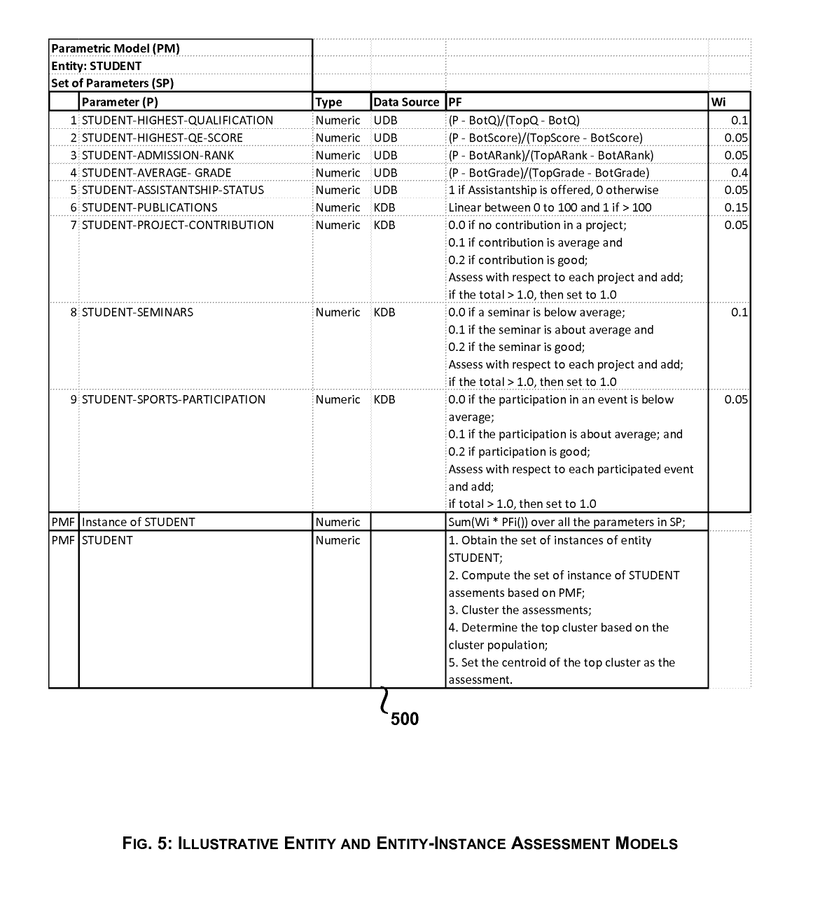

FIG. 5 depicts an illustrative Entity and Entity-Instance Assessment Models. 500 depicts the illustrative parametric model associated with the entity STUDENT. Note that each parameter is associated with a data source that is used to compute the value for the parameter for any entity-instance using the associated parameter function PF. Finally, the parametric model function (PMF) combines these parameter values and in the illustrative model based on the weights associated with each of the parameters.

FIG. 5a depicts additional Illustrative Entity and Entity-Instance Assessment Models. 520 depicts the illustrative hierarchical model related to the entity LIBRARY. Note that LIBRARY is analyzed and decomposed into next level sub-entities: BOOK, LIBRARY MEMBER, STAFF MEMBER, INFRASTRUCTURE. Further, each of these sub-entities are further decomposed as illustrated.

FIG. 5b depicts additional Illustrative Entity and Entity-Instance Assessment Models. 540 depicts an illustrative activity based model related to the entity FACULTY MEMBER. Note that entity is analyzed from the activities point of view and decomposed into activities such as RESEARCH, TEACHES, EXECUTES, EVALUATES, GIVES TALKS, and CO-AUTHORS. Further, each of these activities are further analyzed to build an activity hierarchy as illustrated.

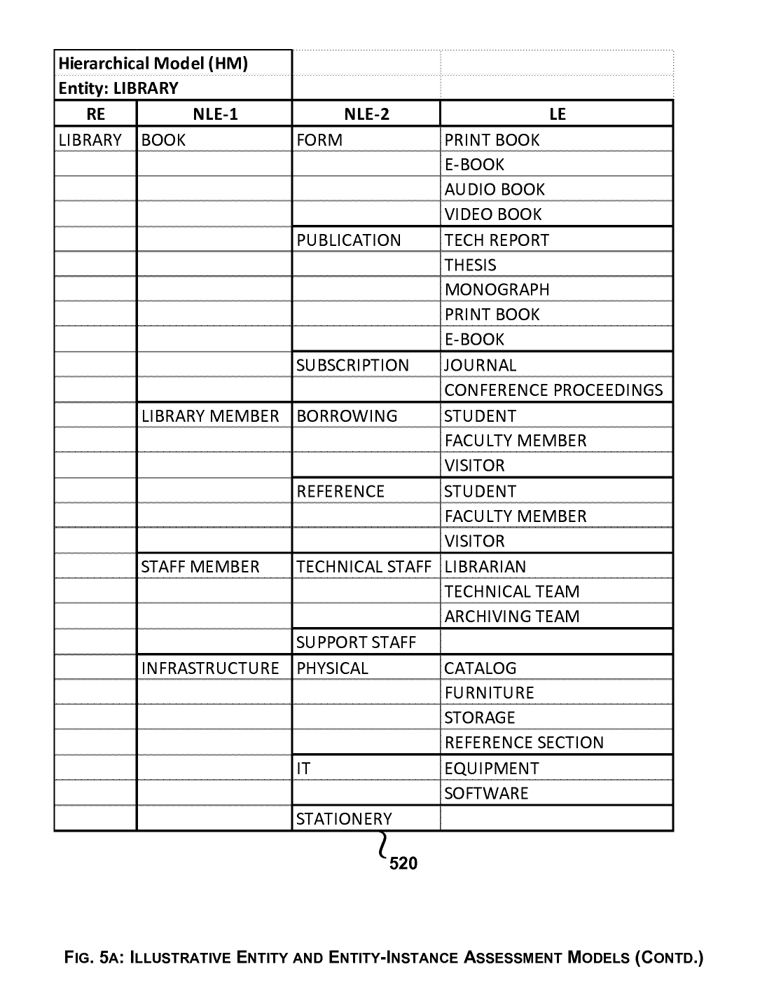

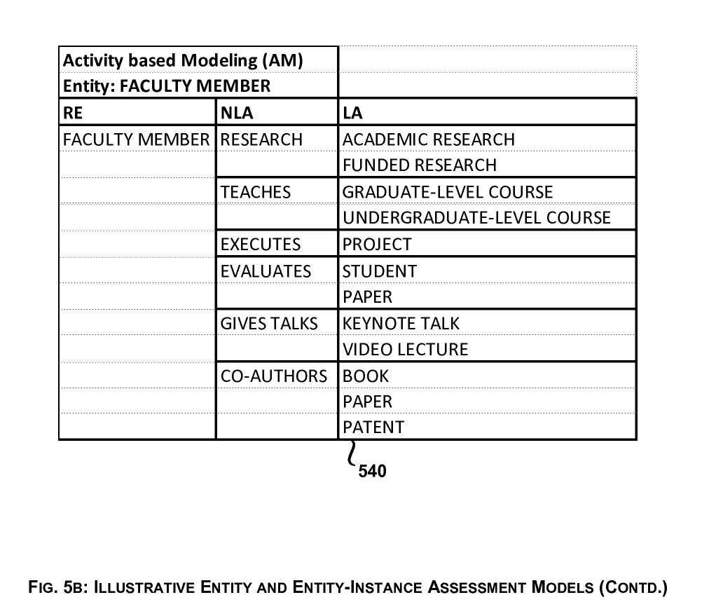

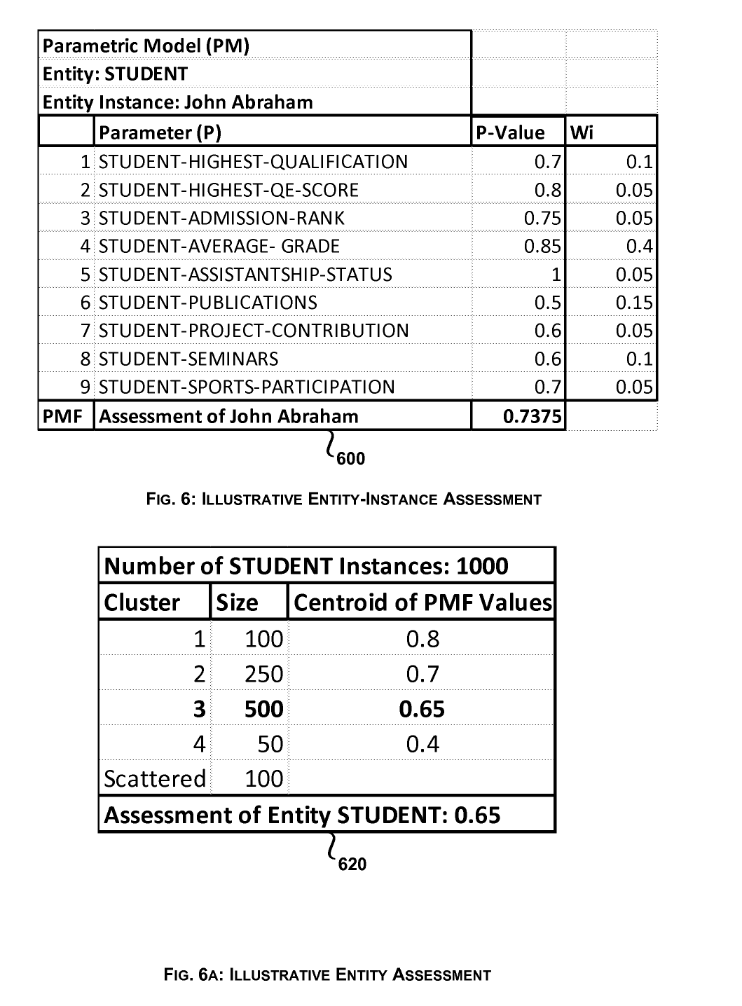

FIG. 6 depicts an illustrative Entity-Instance Assessment. 600 depicts the illustrative assessment of an instance of STUDENT entity, namely, John Abraham. Note that the various parameter values are computed based on the information in UDB and KDB and the final assessments is based on the weights associated with the various parameters.

FIG. 6a depicts an illustrative Entity Assessment. 620 depicts the illustrative assessment of the entity STUDENT. In this assessment, there are 1000 instances of STUDENT and the assessment of these instances are clustered to determine 4 clusters and one scattered cluster (rest of the instances). The cluster centroid is computed for each of the clusters and the entity assessment is based on the centroid of the thickly populated cluster.

FIG. 6b depicts an illustrative Entity Assessment based on Hierarchical Modeling. 640 depicts the illustrative assessment based on hierarchical modeling. The LE values associated with leaf-level entities are derived based on parametric model functions associated with these entities. The NLE-2 values are computed based on the assessment of the leaf-level entities as depicted. For example, SNLE-Value associated with the non-leaf level entity, FORM, is based on the weighted sum of the assessments of its leaf-level entities. Further, each non-leaf entity is also associated with a set of parameters and based UDB and KDB, SP-Value is computed. The NLE-Value associated with FORM is based on SNLE-Value and SP-Value. This process is repeated and finally, the NLE-Value associated with the root entity is the assessment of the entity under consideration.

FIG. 6c depicts an illustrative Entity-Instance Assessment based on Activity based Modeling. 660 depicts the illustrative assessment based on activity modeling. As in the case of hierarchical model based assessment, the assessment of the root entity is based on the assessment of the leaf-level activities and non-leaf level activities.

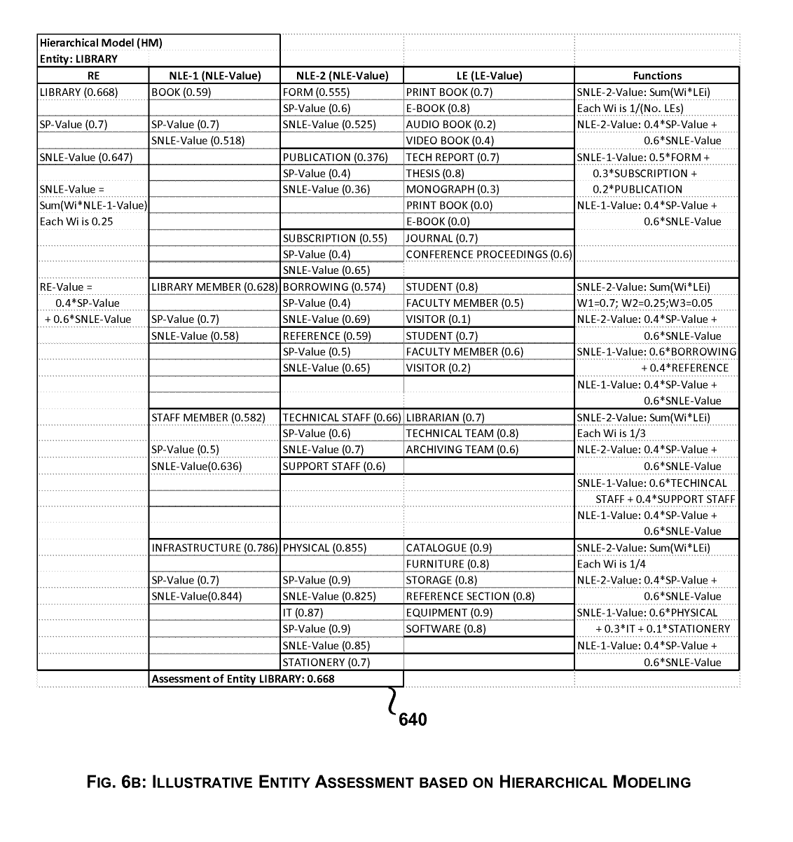

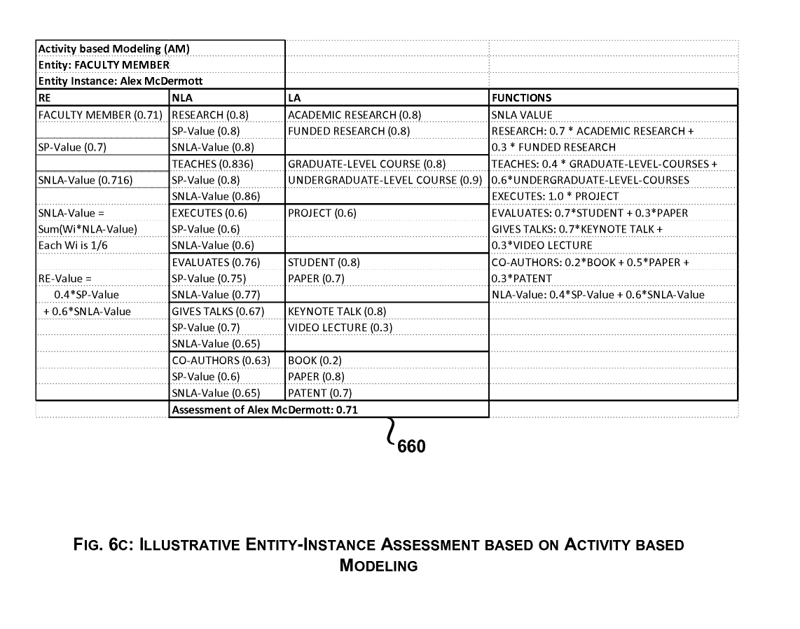

FIG. 7 describes the aspects of I-Value Computation.

Aspects of and Means for Obtaining of Information for I-Value Computation (700):
1. Consider a pair of entity instances: IEi (of Entity Ei) and Iej (of Entity Ej);
   Iij (710) is the I-Value associated with the influence factor; That is, this indicates the quantification of the influence of Ei on Ej;
2. Factors affecting the I-Value computation:
   (a) Each entity Ei is associated with an assessment: assessments are at two levels:
      One, at Entity level and the second, at Entity-Instance level;
      These assessments are also called as base scores; These base scores change over a period of time leading to the change in I-Value;
   (b) Consider the set transactions with respect to UDB and KDB over a period of time;
      The co-occurrence of IEi and IEj in the above set of transactions (LCOT) is another factor that affects I-Value computation; and
   (c) The special attributes of IEi and IEj; These attributes are called as I-Params;
3. Double Time Series:
   (a) The Two time series (720 and 730) are related from the point of view of I-Value;
      The top time series (720) depicts the variation in base score or assessment of an entity instance IEi over a period of time;
      The bottom time series (730) depicts the variation in the co-occurrence frequency between say, IEi and another entity instance, IEj;
   (b) For the purposes of analysis, the timeline is divided into multiple segments and these segments could be any unit of interest, say, days, weeks, or months;

FIG. 7a provides additional information about the aspects of I-Value Computation.

Aspects of Means for Obtaining of Information for I-Value Computation (Contd.) (750):
4. In order to formalize further the aspects of I-Value computation, consider IEi influencing the entity instance IEj;
   (a) Positive Influencers (PIs) are defined with respect to a pair of entities, say, Ei and Ej; These PIs form part of a List of Positive Influencers (LoPI);
   (b) Negative Influencers (NIs) are also defined with respect to the pair of entities; These NIs form part of a list of Negative Influencers (LoNI);
   (c) A P-Perspective (PP) with respect to an entity, say, Ei (Ej), defines the extent of impact of positive influence of LoPI on Ei (Ej);
   (d) Similarly, an N-Perspective (NP) with respect to an entity, say, Ei (Ej) defines the extent of impact of negative influence of LoNI on Ei (Ej);
   (e) Generally, a perspective from an entity point of view provides a quantum of positiveness or negativeness;
   (f) Consider a pair of entities: STUDENT and FACULTY MEMBER: Illustrative LoPI: Good grade obtained by STUDENT in a course offered by FACULTY MEMBER; A Good number of technical discussions between STUDENT and FACULTY MEMBER; and STUDENT is in top 10% in FACULTY MEMBER class; Illustrative LoNI: A low grade awarded to STUDENT by FACULTY MEMBER; and A poor attendance record of STUDENT in a class by FACULTY MEMBER;
   (g) Consider PI: A Good Grade by STUDENT in a class by FACULTY MEMBER; STUDENT perspective: 0.7 while FACULTY MEMBER perspective: 0.2; A consistent performance results in a value of 0.6;
   (h) Each PI associated with Ei and Ej has two perspectives: one associated with Ei and another associated with Ej; these two perspectives are a value between 0 and 1;
   (i) Each NI associated with Ei and Ej has two perspectives: one associated with Ei and another associated with Ej; these two perspectives are a value between 0 and 1;

760 summarizes the various aspects: I-Value (770) between a pair of entities Ei and Ej is mutual as depicted by a bi-directional arrow: that is, Ei influences Ej and Ej influences Ei; further, LoPI has two perspectives (PPi and PPj) and similarly, LoNI has two perspectives (PNi and PNj).

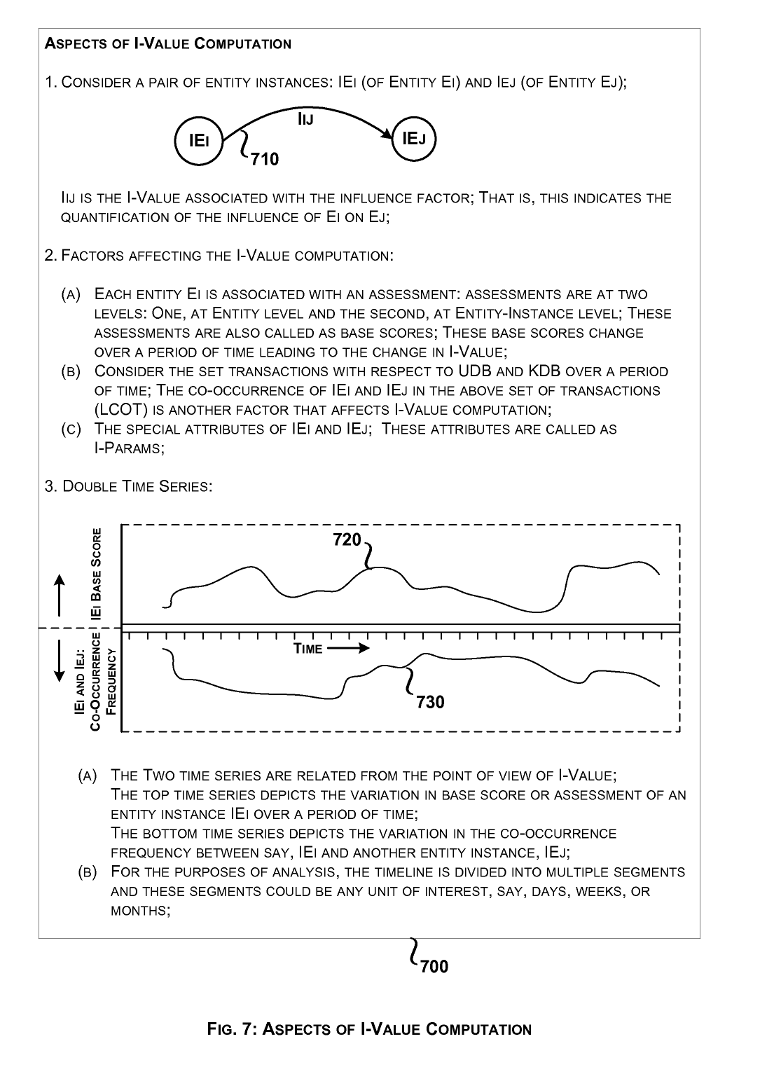

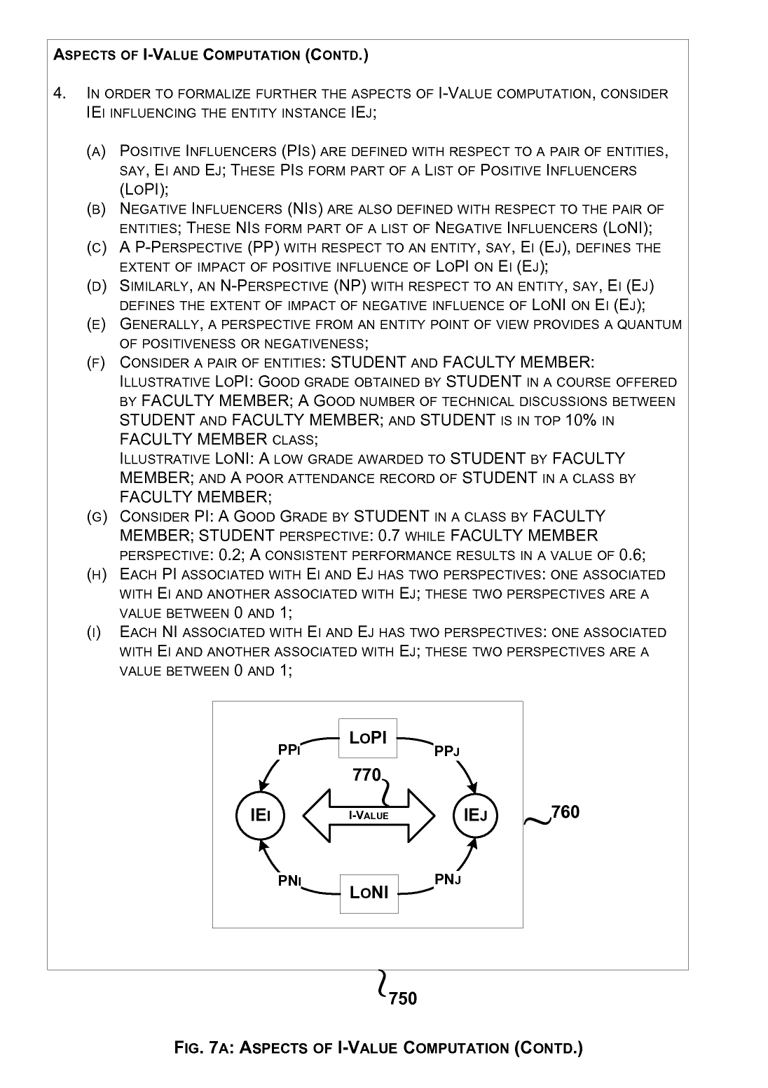

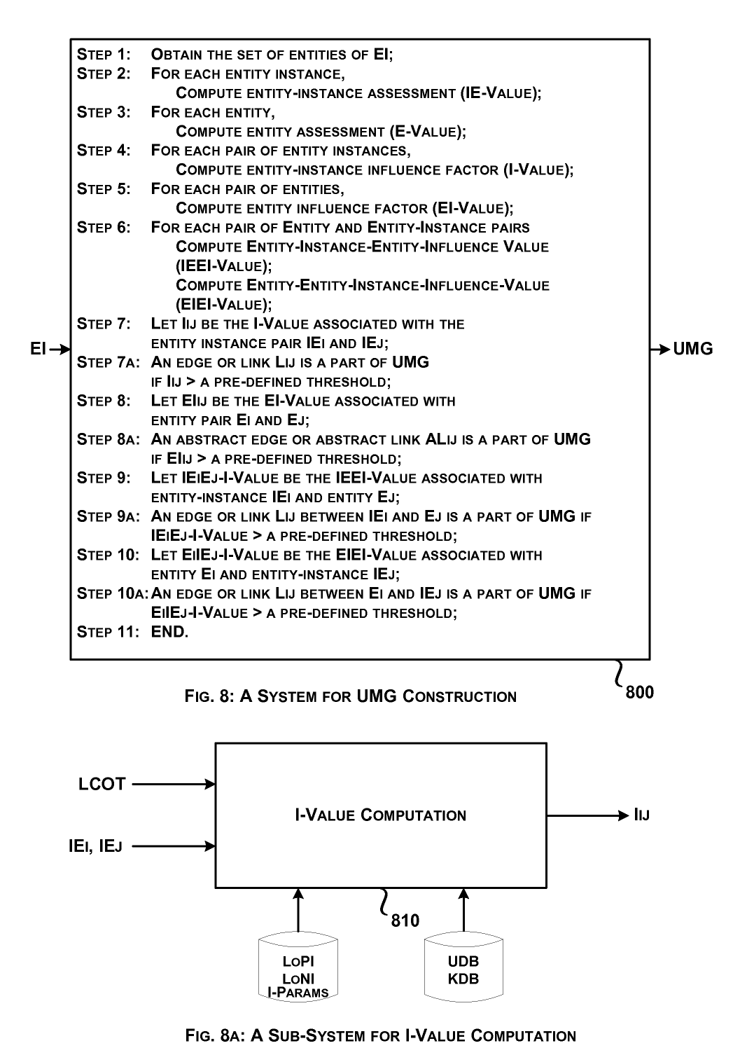

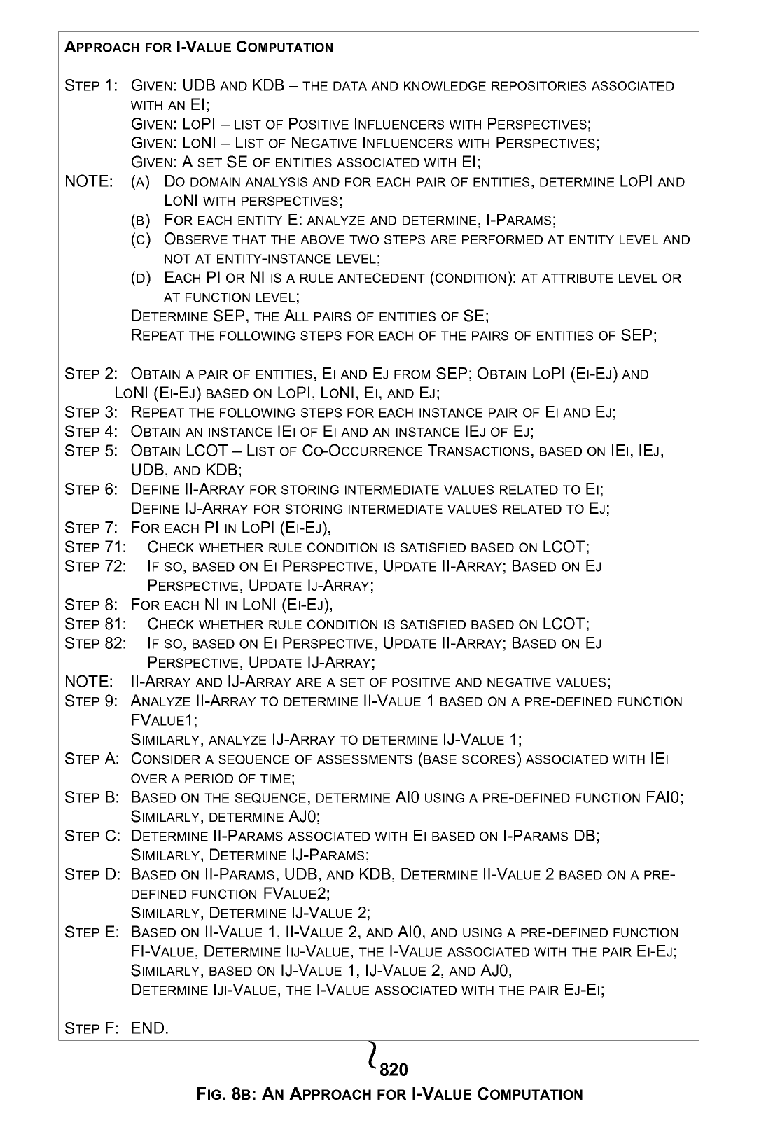

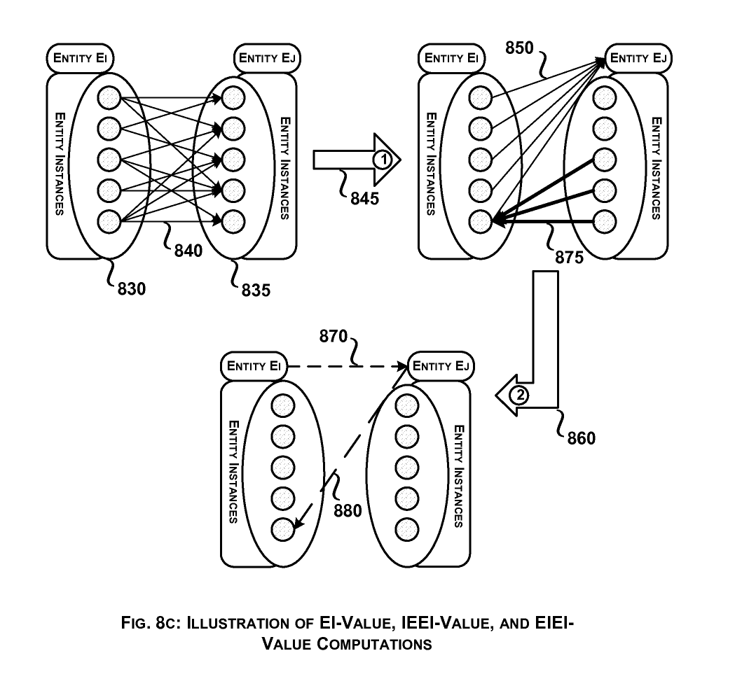

FIG. 8 describes a system for UMG Construction. The overall objective is to construct a University Model Graph for an Educational Institution EI (800) and the means for the construction of the university model graph are as follows.

Step 1: Obtain the set of entities of EI;

Step 2: For each entity instance,
Compute entity-instance assessment (IE-Value);

Step 3: For each entity,
Compute entity assessment (E-Value);

Step 4: For each pair of entity instances,
Compute entity-instance influence factor (I-Value);

Step 5: For each pair of entities,
Compute entity influence factor (EI-Value);

Step 6: For each pair of Entity and Entity-Instance pairs
Compute Entity-Instance-Entity-Influence Value (IEEI-Value);
Compute Entity-Entity-Instance-Influence-Value (EIEI-Value);

Step 7: Let Iij be the I-Value associated with the entity instance pair IEi and IEj;

Step 7a: An edge or link Lij is a part of UMG if Iij>a pre-defined threshold;

Step 8: Let EIij be the EI-Value associated with entity pair Ei and Ej;

Step 8a: An abstract edge or abstract link ALij is a part of UMG if EIij>a pre-defined threshold;

Step 9: Let IEiEj-I-Value be the IEEI-Value associated with entity-instance IEi and entity Ej;

Step 9a: An edge or link Lij between IEi and Ej is a part of UMG
if IEiEj-I-Value>a pre-defined threshold;

Step 10: Let EiIEj-I-Value be the EIEI-Value associated with entity Ei and entity-instance IEj;

Step 10a: An edge or link Lij between Ei and IEj is a part of UMG
if EiIEj-I-Value >a pre-defined threshold;

Step 11: END.

FIG. 8a describes a sub-system for I-Value Computation.

I-Value Computation is for a Pair of Entity Instances (IEi and IEj) and Uses the Databases Related to UDB, KDB, LoPI, and LoNI Along with LCOT to Compute Iij (810).

FIG. 8b describes an approach for I-Value Computation.

Means and Approach for I-Value Computation (820):
Step 1:
   Given: UDB and KDB—the data and knowledge repositories associated with an EI;
   Given: LoPI—list of Positive Influencers with Perspectives;
   Given: LoNI—List of Negative Influencers with Perspectives;
   Given: A set SE of entities associated with EI;
   NOTE: (a) Do domain analysis and for each pair of entities, determine LoPI and LoNI with perspectives;
   (b) For each entity E: analyze and determine, I-Params;
   (c) Observe that the above two steps are performed at entity level and not at entity-instance level;
   (d) Each PI or NI is a rule antecedent (condition): at attribute level or at function level;
   Determine SEP, the All pairs of entities of SE;
   Repeat the following steps for each of the pairs of entities of SEP;
Step 2: Obtain a pair of entities, Ei and Ej from SEP; Obtain LoPI (Ei-Ej) and
   LoNI (Ei-Ej) based on LoPI, LoNI, Ei, and Ej;
Step 3: Repeat the following steps for each instance pair of Ei and Ej;
Step 4: Obtain an instance IEi of Ei and an instance IEj of Ej;
Step 5: Obtain LCOT—List of Co-Occurrence Transactions, based on IEi, IEj, UDB, and KDB;
Step 6: Define II-Array for storing intermediate values related to Ei;
   Define IJ-Array for storing intermediate values related to Ej;
Step 7: For each PI in LoPI (Ei-Ej),
Step 71: Check whether rule condition is satisfied based on LCOT;
Step 72: If so, based on Ei Perspective, Update II-Array;
   Based on Ej, Perspective, Update Ij-Array;
Step 8: For each NI in LoNI (Ei-Ej),
Step 81: Check whether rule condition is satisfied based on LCOT;
Step 82: If so, based on Ei Perspective, Update II-Array;
   Based on Ej, Perspective, Update IJ-Array;

NOTE: II-Array (also referred as a plurality of pn values) and IJ-Array are a set of positive and negative values;
Step 9: Analyze II-Array to determine II-Value 1 (also referred as an influence component 1) based on a pre-defined function FValue1;
   Similarly, analyze IJ-Array to determine IJ-Value 1;
Step A: Consider a sequence of assessments (base scores) associated with IEi over a period of time;
Step B: Based on the sequence, determine AI0 (also referred as an influence component 2) using a pre-defined function FAI0;
   Similarly, determine AJ0;
Step C: Determine II-Params (also referred as a plurality of influencing parameters) associated with Ei based on I-Params DB;
   Similarly, Determine IJ-Params;
   Step D: Based on II-Params, UDB, and KDB, Determine II-Value 2 (also referred as an influence component 3) based on a pre-defined function FValue2;
   Similarly, Determine IJ-Value 2;
Step E: Based on II-Value 1, II-Value 2, and AM, and using a pre-defined function FI-Value,
   Determine Iij-Value, the I-Value associated with the pair Ei-Ej;
   Similarly, based on IJ-Value 1, IJ-Value 2, and AJ0,
   Determine Iji-Value, the I-Value associated with the pair Ej-Ei;
Step F: END.

FIG. 8c provides an illustration of EI-Value , IEEI-Value, and EIEI-Value Computations. Consider two entities Ei and Ej; 830 describes the instances of Ei and 835 describes the instances of Ej; and the EI-Value is related to the influence of the entity Ei upon the entity Ej. This computation is based on the I-Values associated with the directed edge connecting 830 and 835 (840). Consider an instance of Ei; this influences multiple instances of Ej as depicted. The first step (845) is to reduce the I-Value associated with these multiple instances into a single value (850). At this stage, the computed single influence value is associated with the entity Ej as depicted. Note that this computed single influence value depicts the computation of IEEI-Value. This is repeated for each of the instances of Ei. Observe that multiple single values get associated with Ej. The next step (860) is to reduce these multiple single values to the EI-Value associated with the abstract link between Ei and Ej (870). In order to compute EIEI-Value, consider the multiple instances of Ej that influence an instance IEi of Ei (875). Reducing of the I-Vaues associated with these multiple instances into a single value results in the computation of EIEI-Value (880).

FIG. 8d depicts an approach for EI-Value, IEEI-Value, and EIEI-Value Computations. Means and Approach for EI-Value, IEEI-Value, and EIEI-Value Computations (880):
Step 1: Given: A set SE of entities associated with EI;
   Determine SEP, the All pairs of entities of SE;
   Repeat the following steps for each of the pairs of entities of SEP;
Step 2: Obtain a pair of entities, Ei and Ej from SEP;
Step 3: Let SIEi be the set of instance of Ei;
   Similarly, let SIEj be the set of instances of Ej;
Step 4: For each IEi of SIEi,
Step 41: Let Sj be the set of instances of Ej influenced by IEi;
Step 42: Determine ISj based on I-Value associated with each of Sj;

Note: ISj is a sequence of positive and negative values between −1 and 1;
Step 43: Let PIS be the set of positive values based on ISj;
   Similarly, let NIS be the set of negative values based on ISj;
Step 44: Compute clusters CPI of elements of PIS based on a pre-defined threshold;
   Similarly, compute clusters CNI of elements of NIS based on a pre-defined threshold;
Step 45: Select clusters of CPI into SCPI such that the population of each cluster of SCPI>a pre-defined threshold;
   Similarly, Select clusters of CNI into SCNI such that the population of each cluster of SCNI >a pre-defined threshold;
Step 46: Determine total population size PI based on SCPI and SCNI;
Step 47: Select top clusters of SCPI into SPI such that the combined population size>a pre-defined threshold based on PI;
   Similarly, select top clusters of SCNI into SNI such that the combined population size>a pre-defined threshold based on PI;
Step 48: Determine the centroid PCi of each cluster of SPI based on the population of the ith cluster of SPI;
Step 49: Similarly, determine the centroid NCi of each cluster of SNI based on the population of the ith cluster of SNI;
Step 4a: Compute the set of weights associated with the clusters of SPI and SNI based on the population of the clusters;
Step 4b: Compute IiEiEj-Value, the influence of the instance IEi of Ei on Ej based on the set of positive centroid values, the set of negative centroid values, and the corresponding weights;
Step 4c: IEiEj-I-Value forms the basis for the computation of IEEI-Value between IEi and Ej;
Step 4d: Determine the set of instances Sj1 of Ej that influence Ei;
Step 4e: Determine ISj1 based on I-Value associated with each of Sj1;

Note: ISj1 is a sequence of positive and negative values between −1 and 1;
Step 4f: Repeat Step 41 through 4b with respect to ISj1-Value to determine EIEI-Value between Ej and IEi;
Step 4g: Make IEiEj-I-Value a part of SEj-Value;

Note: SEj-Value is a set of positive and negative numbers between −1 and 1;
Step 5: Repeat Step 41 through 4b with respect to SEj-Value to determine EijI-Value;
Step 6: END.

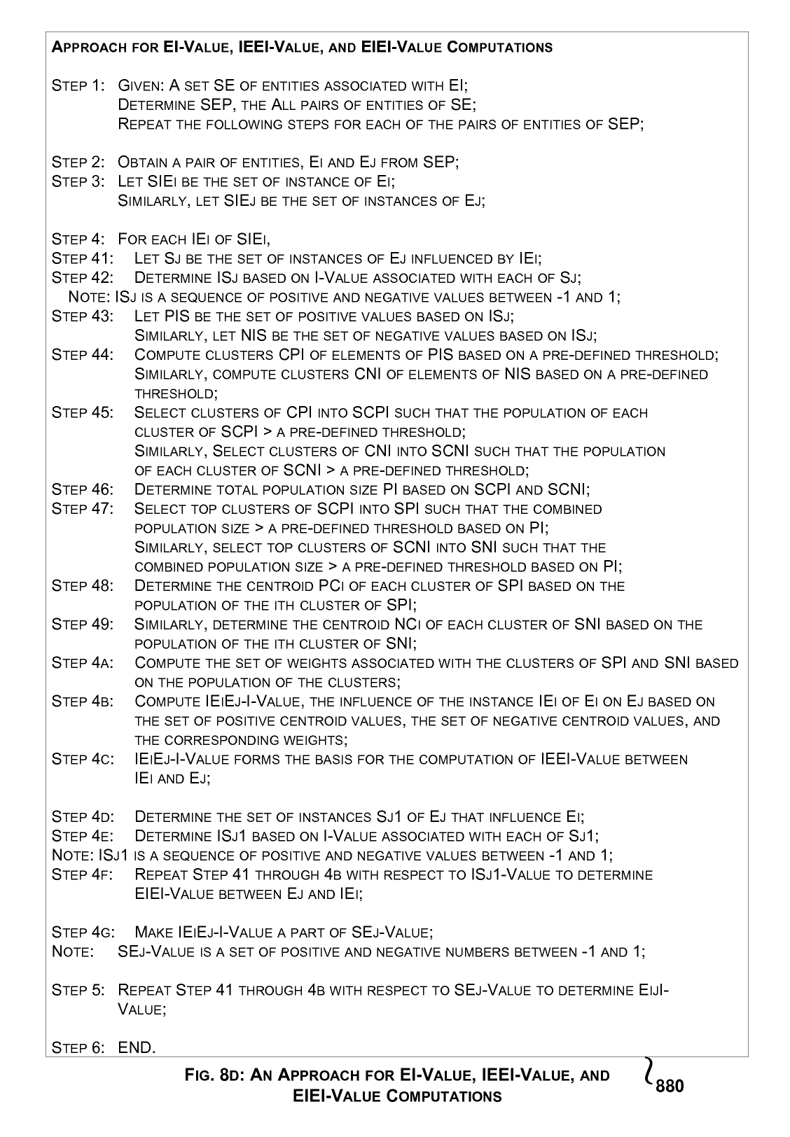

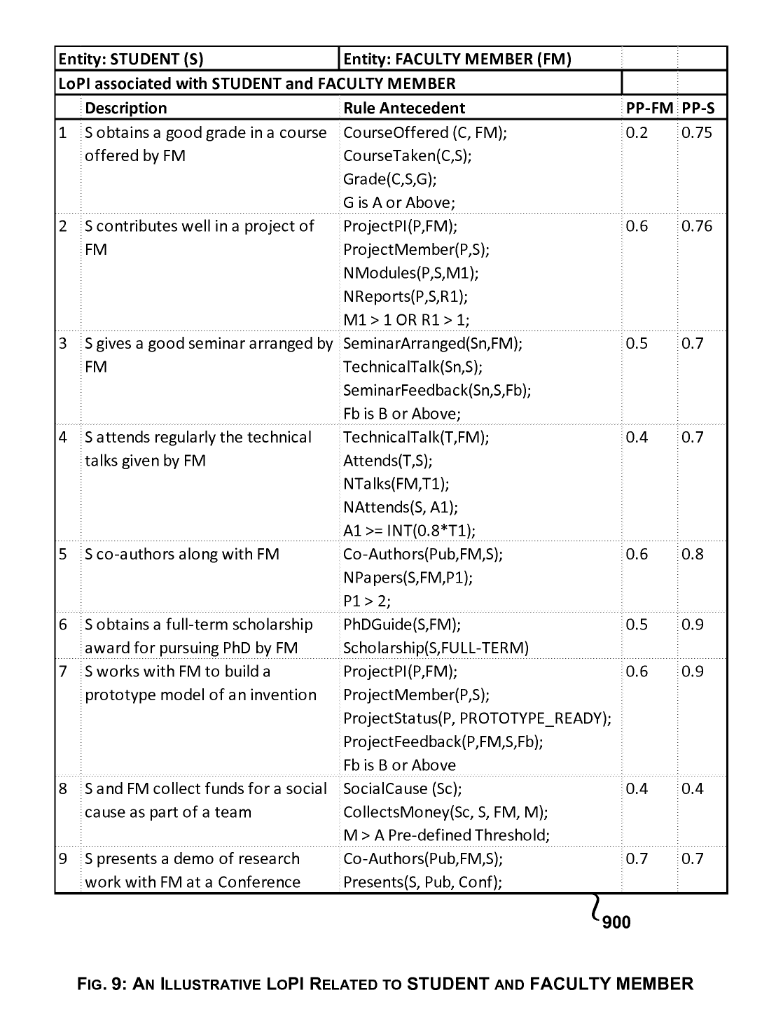

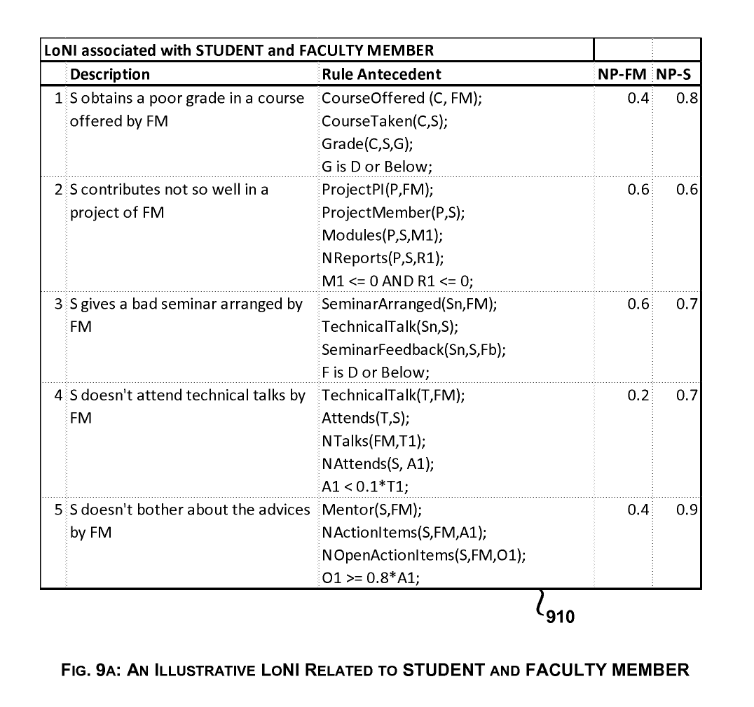

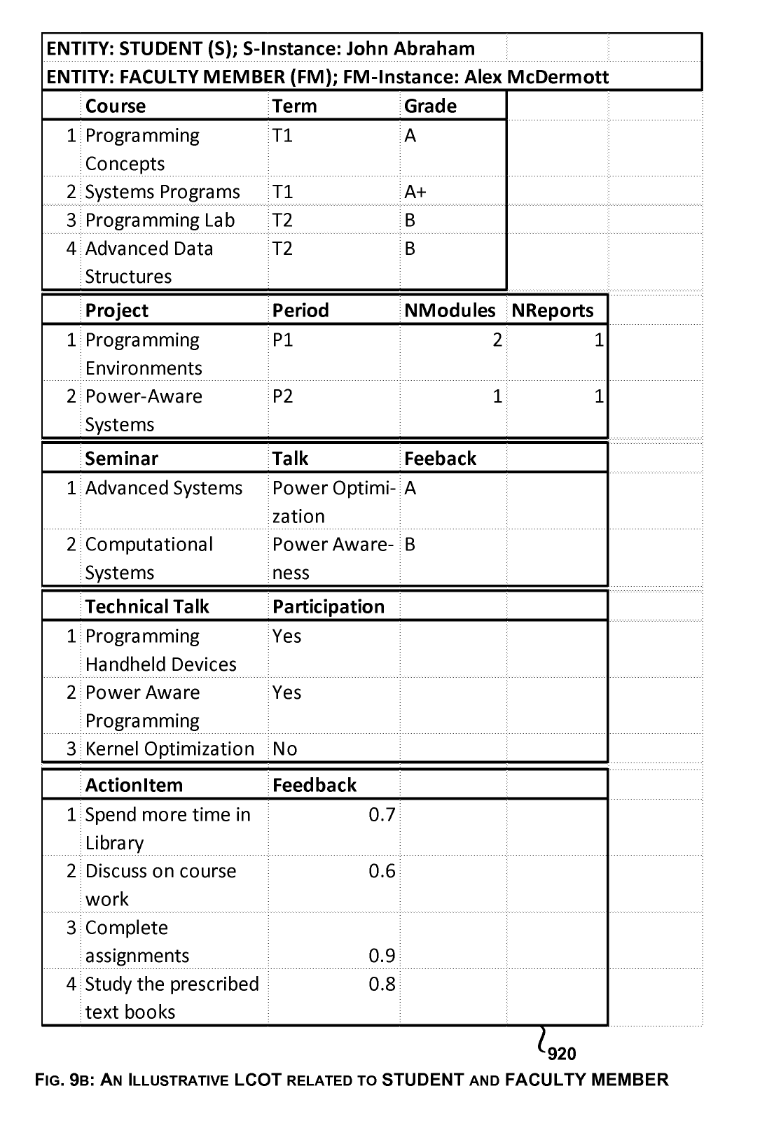

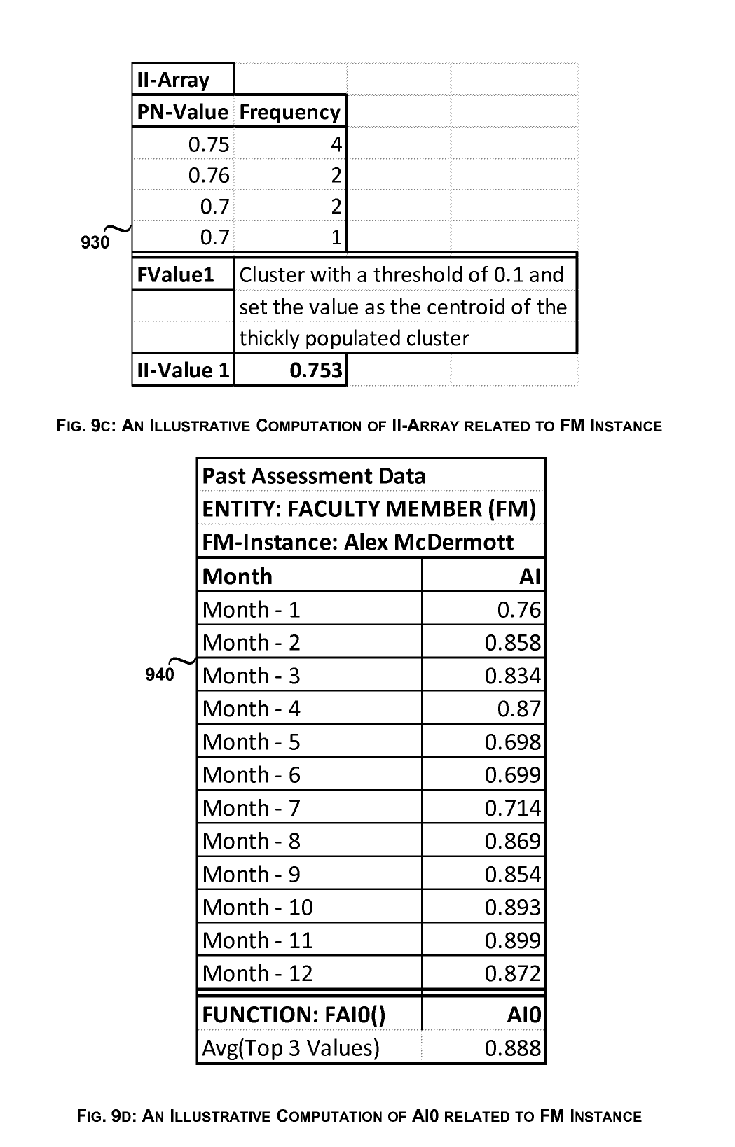

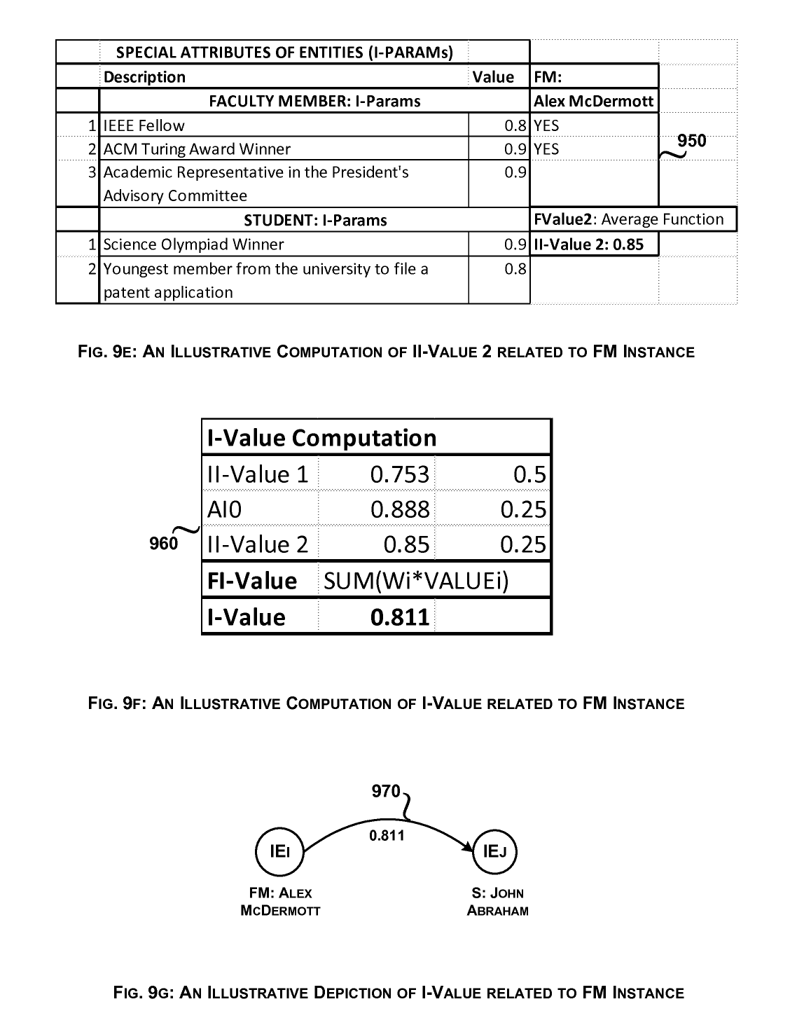

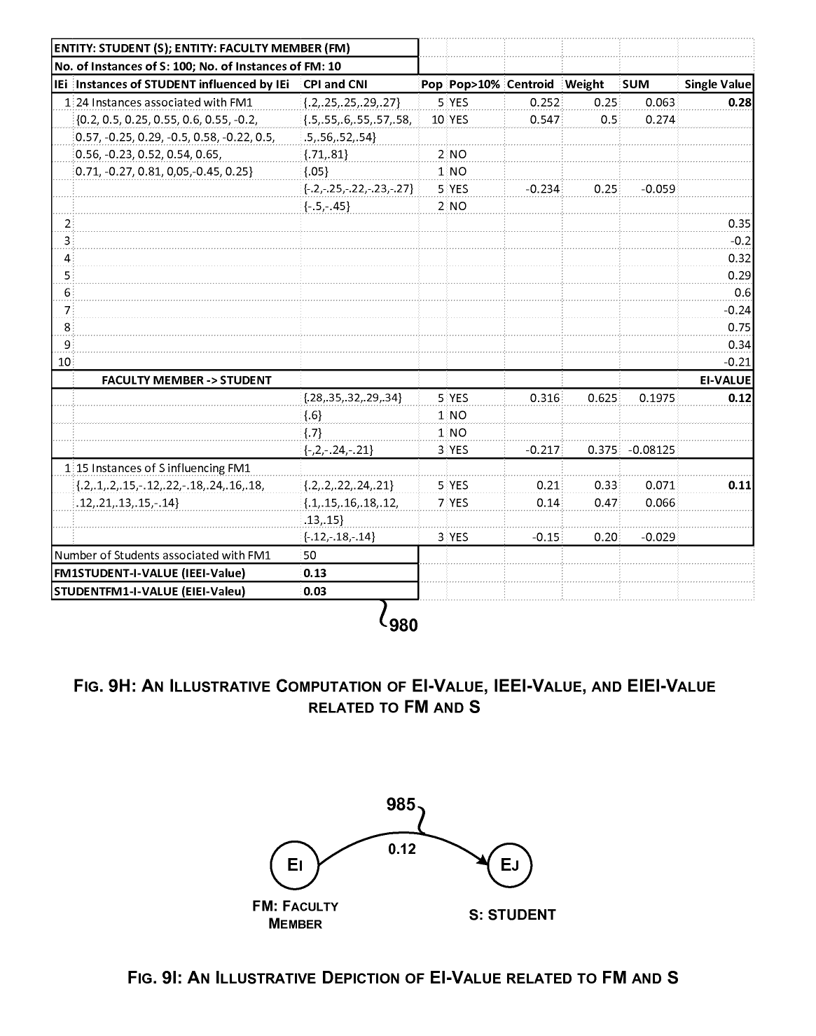

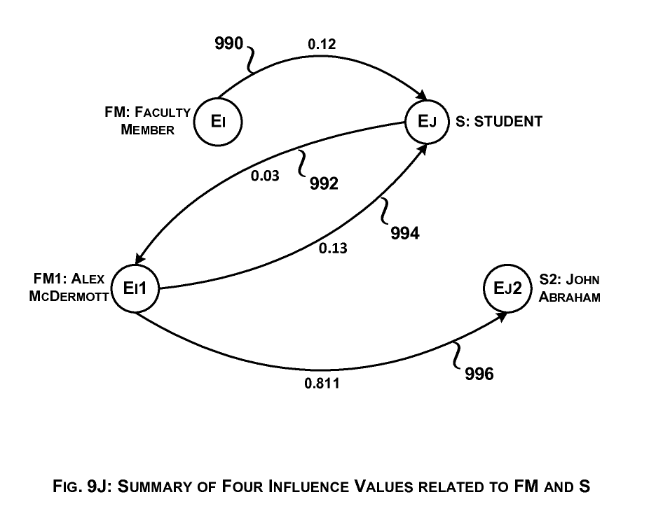

FIG. 9 provides an illustrative LoPI related to STUDENT and FACULTY MEMBER. 900 depicts an illustrative LoPI. Two entities under consideration are STUDENT and FACULTY MEMBER. Consider a positive influencer “a student obtains a good grade in a course offered by a faculty member”: the rule antecedent clearly defines how to determine whether this influencer is satisfied by a particular instantiated value for STUDENT and FACULTY MEMBER; Further, the perspectives from STUDENT and FACULTY MEMEBR point of view are also depicted.

FIG. 9a provides an illustrative LoNI related to STUDENT and FACULTY MEMBER. As in the case of LoPI, 910 depicts a few illustrative negative influencers.

FIG. 9b provides an illustrative LCOT related to STUDENT and FACULTY MEMBER. The list of co-occurrence transactions related to a pair of entity instances related to STUDENT entity (instance John Abraham) and FACULTY MEMBER entity (instance Alex McDermott) is depicted in 920. The data depicted is used in assessing the relevance of LoPI and LoNI for the entity instance pair under consideration.

FIG. 9c provides an illustrative computation of II-Array related to FM Instance. 930 depicts the computational results: II-Array indicates how the various influencers in LoPI and LoNI got evaluated with respect to LCOT. This is a sequence of positive and negative values (between 0 and 1) as indicated in 930 and illustrative pre-defined function FValue1 is to cluster the sequence and obtaining the centroid of the thickly populated cluster and II-Value1 is set with this centroid value.

FIG. 9d provides an illustrative computation of AI0 related to FM Instance. 940 depicts the time series related to the assessment (base score) of the entity instance under consideration over the last Twelve months. The illustrative pre-defined function FAI0 is compute the average of the top three peak values of the time series.

FIG. 9e provides an illustrative computation of II-Value 2 related to FM Instance. 950 depicts the illustrative I-Params related to the STUDENT entity and FACULTY MEMBER entity. Also depicted is the assessment of the I-Params with respect to an instance of FACULTY MEMBER Alex McDermott. II-Value2 computation is based on the pre-defined function (illustrated is the Average Function) and the I-Params assessments.

FIG. 9f provides an illustrative computation of I-Value related to FM Instance. 960 depicts the computation of I-Value based on II-Value1, AM, and II-Value 2 using a pre-defined function (illustrated is the Weighted Sum).

FIG. 9g provides an illustrative depiction of I-Value related to FM Instance. Note that I-Value is the weight associated with a link connecting two entity instances (970). Illustrated is the nature and quantum of influence by the faculty member Alex McDermott on the student John Abraham.

FIG. 9h provides an illustrative computation of EI-Value, EI-Value, IEEI-Value, and EIEI-Value related to FM and S. 980 depicts illustrative instances of FACULTY MEMBER (about ten instances) and shows the instances of the entity STUDENT influenced by FM 1 (about twenty four of them). The figure also indicates the intermediate values leading to the computation of IEiEj-I-Value 0.28 (Single Value). Note that this forms the basis for the computation of IEEI-Value 0.13 between FM1 and S. The multiple single values with respect to the various of FACULTY MEMBER instances are analyzed to arrive at EI-Value (0.12). In order to compute EIEI-Value between STUDENT and FM1, fifteen instances of S influencing FM1 are considered. The resulting single value 0.11 forms the basis for the computation of EIEI-Value of 0.03 between STUDENT and FM1.

FIG. 9i provides an illustrative depiction of EI-Value related to FM and S. 985 indicates the influence factor of 0.12 associated with an abstract directed link from the entity FACULTY MEMBER to the entity STUDENT.

FIG. 9J provides the summary of Four Influence Values related to FM and S. Observe that 990 depicts EI-Value of 0.12 between FM and S, 992 depicts the EIEI-Value of 0.03 between S and FM1, and 994 depicts the IEEI-Value of 0.13 between FM1 and S Finally, 996 depicts the I-Value of 0.811 between FM1 and S2.

Thus, a system and method for the construction of a university model graph of a university is disclosed. Although the present invention has been described particularly with reference to the figures, it will be apparent to one of the ordinary skill in the art that the present invention may appear in any number of systems that construct influence based structural representation. It is further contemplated that many changes and modifications may be made by one of ordinary skill in the art without departing from the spirit and scope of the present invention.

We claim:

1. A system for the construction of a university model graph of a university based on a plurality of assessments and a plurality of influence values to assist in the assessment of said university at multiple levels using a university database, a university knowledgebase, a plurality of models and a plurality of influencers,
said university having a plurality of entities and a plurality of entity-instances, wherein
each of said plurality of entity-instances is an instance of an entity of said plurality of entities, and said university model graph having a plurality of abstract nodes, a plurality of nodes, a plurality of abstract edges, a plurality of semi-abstract edges, and a plurality of edges,
with each abstract node of said plurality of abstract nodes corresponding to an entity of said plurality of entities,
each node of said plurality of nodes corresponding to an entity-instance of said plurality of entity-instances, and
each abstract node of said plurality of abstract nodes is associated with a model of said plurality of models, and
a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,
a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;
a source node of said plurality of nodes is connected to a destination node of said plurality of nodes by a directed edge of said plurality of edges and said directed edge is associated with an influence value of said plurality influence values, wherein said influence value is a value between −1 and +1;
a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said influence value is a value between −1 and +1; and
a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said influence value is a value between −1 and +1,
said system comprising:
means for obtaining of said plurality of models, wherein said plurality of models comprises a plurality of parametric models, a plurality of hierarchical models, and a plurality of activity based models;
means for obtaining of said plurality of influencers associated with a plurality of pair of entities wherein an entity 1 of a pair of entities of said plurality of pair of entities is a part of said plurality of entities and an entity 2 of said pair of entities of said plurality of pair of entities is a part of said plurality of entities;
means for computing of an entity-instance assessment of said plurality of assessments, wherein said entity-instance assessment is associated with an entity-instance of said plurality of entity-instances;
means for computing of an entity assessment of said plurality of assessments, wherein said entity assessment is associated with an entity of said plurality of entities;
means for computing of an influence value, of said plurality of influence values, associated with a source entity-instance and a destination entity-instance, wherein said source entity-instance is a part of said plurality of entity-instances and said destination entity-instance is a part of said plurality of entity-instances;
means for assigning of said influence value to a directed edge, of said plurality of edges, from a source node of said plurality of nodes to a destination node of said plurality of nodes, wherein said source node is associated with said source entity-instance and said destination node is associated with said destination entity-instance;
means for computing of an entity influence value, of said plurality of influence values, associated with a source entity and a destination entity, wherein said source entity is a part of said plurality of entities and said destination entity is a part of said plurality of entities;
means for assigning of said entity influence value to a directed abstract edge, of said plurality of abstract edges, from a source abstract node of said plurality abstract nodes to a destination abstract node of said plurality of abstract nodes, wherein said source abstract node is associated with said source entity and said destination abstract node is associated with said destination entity;
means for computing of an entity-instance-entity-influence value, of said plurality of influence values, associated with a source entity-instance and a destination entity, wherein said source entity-instance is a part of said plurality of entity-instances and said destination entity is a part of said plurality of entities;
means for assigning of said entity-instance-entity-influence value to a directed semi-abstract edge, of said plurality of semi-abstract edges, from a source node of said plurality of nodes to a destination abstract node of said plurality of abstract nodes, wherein said source node is associated with said source entity-instance and said destination abstract node is associated with said destination entity;
means for computing of an entity-entity-instance-influence value, of said plurality of influence values, associated with a source entity and a destination entity-instance, wherein said source entity is a part of said plurality of entities and said destination entity-instance is a part of said plurality of entity-instances; and
means for assigning of said entity-entity-instance-influence value to a directed semi-abstract link, of said plurality of semi-abstract links, from a source abstract node of said plurality of abstract nodes to a destination node of said plurality of nodes, wherein said source abstract node is associated with said source entity and said destination node is associated with said destination entity-instance.

2. The system as claimed in claim 1, wherein said means for obtaining of said plurality of models further comprises:
means for obtaining of a parametric model of said plurality of parametric models of said plurality of models;
means for obtaining of an entity of said plurality of entities;
means for obtaining of a plurality of parameters associated with said entity;
means for obtaining of a parameter function associated with a parameter of said plurality of parameters based on a plurality of data elements of said university database and a plurality data elements of said university knowledgebase;
means for obtaining of a parametric model function based on said plurality of parameters;
means for assigning of said parametric model function to said parametric model;
means for assigning of said parametric model to an abstract node of said plurality of abstract nodes, wherein said abstract node is associated with said entity;
means for obtaining of an entity-instance of said plurality of entity-instances, wherein said entity-instance in an instance of said entity;
means for obtaining of a parametric model instance based on said parametric model and said entity-instance; and
means for assigning of said parametric model instance to a node of said plurality of nodes, wherein said node is associated with said entity-instance.

3. The system as claimed in claim 2, wherein said means for obtaining of said plurality of models further comprises:
means for obtaining of a hierarchical model of said plurality of hierarchical models of said plurality of models;
means for obtaining of an entity of said plurality of entities;
means for obtaining of a plurality of sub-entities, wherein a sub-entity of said plurality of sub-entities is a division of said entity;
means for obtaining of a plurality of sub-sub-entities, wherein each sub-sub-entity of said plurality of sub-sub-entities is a division of a sub-entity of said plurality of sub-entities or a division of a sub-sub-entity of said plurality of sub-sub-entities or an atomic entity;
means for forming of a hierarchy with said entity, said plurality of sub-entities, and said plurality of sub-sub-entities, wherein said entity is the root of said hierarchy;
means for associating of said hierarchy with said hierarchical model;
means for assigning of said hierarchical model to an abstract node of said plurality of abstract nodes, wherein said abstract node is associated with said entity;
means for obtaining of an entity-instance of said plurality of entity-instances, wherein said entity-instance is an instance of said entity;
means for obtaining a hierarchical model instance based on said hierarchical model and said entity-instance; and
means for assigning of said hierarchical model instance to a node of said plurality of nodes, wherein said node is associated with said entity-instance.

4. The system as claimed in claim 3, wherein said means for obtaining of said hierarchical model further comprises:
means for obtaining of a sub-entity, wherein said sub-entity is at non-leaf level of said hierarchy;
means for determining of a plurality of divisional entities of said sub-entity, wherein each of said plurality of divisional entities is a division of said sub-entity with respect to said hierarchy;
means for obtaining of a plurality of parameters associated with said sib-entity;
means for obtaining of a non-leaf-level function based on said plurality of divisional entities and said plurality of parameters; and
means for assigning of said non-leaf-level function to said sub-entity of said hierarchical model.

5. The system as claimed in claim 3, wherein said means for obtaining of said hierarchical model further comprises:
means for obtaining of a sub-entity, wherein said sub-entity is at leaf level of said hierarchy;
means for obtaining of a plurality of parameters associated with said sub-entity;
means for obtaining of a leaf-level function based on said plurality of parameters; and
means for assigning of said leaf-level function to said sub-entity of said hierarchical model.

6. The system as claimed in claim 2, wherein said means for obtaining of said plurality of models further comprises:
means for obtaining of an activity based model of said plurality of activity based models of said plurality of models;
means for obtaining of an entity of said plurality of entities;
means for obtaining of a plurality of activities, wherein an activity of said plurality of activities is a relevant activity with respect to said entity;
means for obtaining of a plurality of sub-activities, wherein each sub-activity of said plurality of sub-activities is a division of an activity of said plurality of activities or a division of a sub-activities of said plurality of sub-activities or an atomic activity;
means for forming of an activity hierarchy with said entity, said plurality of activities, and said plurality of sub-activities, wherein said entity is the root of said activity hierarchy;
means for associating of said activity hierarchy with said activity based model;
means for assigning of said activity based model to an abstract node of said plurality of abstract nodes, wherein said abstract node is associated with said entity;
means for obtaining of an entity-instance of said plurality of entity-instances, wherein said entity-instance is an instance of said entity;
means for obtaining an activity based model instance based on said activity based model and said entity-instance; and
means for assigning of said activity based model instance to a node of said plurality of nodes, wherein said node is associated with said entity-instance.

7. The system as claimed in claim 6, wherein said means of obtaining of said activity based model further comprises:
means for obtaining of a sub-activity, wherein said sub-activity is at non-leaf level of said activity hierarchy;
means for determining of a plurality of divisional activities of said sub-activity, wherein each of said plurality of divisional activities is a division of said sub-activity with respect to said activity hierarchy;
means for obtaining of a plurality of parameters associated with said sib-activity;
means for obtaining of a non-leaf-level function based on said plurality of divisional activities and said plurality of parameters; and
means for assigning of said non-leaf-level function to said sub-activity of said activity based model.

8. The system as claimed in claim 6, wherein said means of obtaining of said activity based model further comprises:
means for obtaining of a sub-activity, wherein said sub-activity is at leaf level of said activity hierarchy;
means for obtaining of a plurality of parameters associated with said sub-activity;
means for obtaining of a leaf-level function based on said plurality of parameters; and
means for assigning of said leaf-level function to said sub-activity of said activity based model.

9. The system as claimed in claim 1, wherein said means for computing of said entity-instance assessment further comprises:
means for obtaining of said entity-instance;
means for obtaining of an entity associated with said entity-instance;
means for obtaining of a parametric model of said plurality of parametric models of said plurality of models associated with said entity;
means for obtaining of a parametric model instance of said parametric model associated with said entity-instance;
means for obtaining a node of said plurality of nodes associated with said entity-instance;
means for obtaining of a plurality of parameters associated with said parametric model instance;
means for computing of a plurality of parameter values, wherein a parameter value of said plurality of parameter values is based on a parameter of said plurality of parameters, a parameter function associated with said parameter, said university database, said university knowledgebase;
means for obtaining of a parametric model function associated with said parametric model instance;
means for computing of said entity-instance assessment based on said parametric model function and said plurality of parameter values; and
means for assigning of said entity-instance assessment to said node.

10. The system as claimed in claim 9, wherein said means for computing of said entity-instance assessment further comprises:
means for obtaining of said entity-instance;
means for obtaining of an entity associated with said entity-instance;
means for obtaining of a hierarchical model of said plurality of hierarchical models of said plurality of models associated with said entity;
means for obtaining of a hierarchical model instance of said hierarchical model associated with said entity-instance;
means for obtaining of a hierarchy associated with said hierarchical model instance;
means for obtaining a node of said plurality of nodes associated with said entity-instance;
means for obtaining of a plurality of leaf-level entities of said hierarchy; and
means for computing of a plurality of leaf-level entity values associated with said plurality of leaf-level entities, wherein a leaf-level entity value of said plurality of leaf-level entity values is computed based on a leaf-level entity of said plurality of leaf-level entities, a plurality of parameters associated with said leaf-level entity, and a leaf-level entity function associated with said leaf-level entity.

11. The system as claimed in claim 10, wherein said means for computing of said entity-instance assessment further comprises:
means for obtaining of a plurality of non-leaf-level entities of said hierarchy;
means for computing of a plurality of non-leaf-level entity values associated with said plurality of non-leaf-entities;
means for obtaining of an non-leaf-level entity of said plurality of non-leaf-level entities;
means for obtaining of a plurality of parameters associated with non-leaf-level entity;
means for computing of a plurality of parameter values based on said plurality of parameters;
means for obtaining of a plurality of sub-entities associated with said non-leaf-level entity based on said hierarchy;
means for determining of a plurality of sub-entity values based on said plurality of sub-entities;
means for obtaining of a non-leaf-level-entity function associated with said non-leaf-level-entity;
means for computing of a non-leaf-level-entity value associated with said non-leaf-level-entity based on said non-leaf-level-entity function, said plurality of sub-entity values, and said plurality of parameter values;
means for making of said non-leaf-level-entity value a part of said plurality of non-leaf-level entity values;
means for determining of a root-level entity value based on said plurality of non-leaf-level entity values;
means for determining of said entity-instance assessment based on said root-level entity value; and
means for assigning of said entity-instance assessment to said node.

12. The system as claimed in claim 9, wherein said means for computing of said entity-instance assessment further comprises:
means for obtaining of said entity-instance;
means for obtaining of an entity associated with said entity-instance;
means for obtaining of an activity based model, of said plurality of activity based models of said plurality of models, associated with said entity;
means for obtaining of an activity based model instance of said activity based model associated with said entity-instance;
means for obtaining of a hierarchy associated with said activity based model instance;
means for obtaining a node of said plurality of nodes associated with said entity-instance;
means for obtaining of a plurality of leaf-level entities of said hierarchy; and
means for computing of a plurality of leaf-level entity values associated with said plurality of leaf-level entities, wherein a leaf-level entity value of said plurality of leaf-level entity values is computed based on a leaf-level entity of said plurality of leaf-level entities, a plurality of parameters associated with said leaf-level entity, and a leaf-level entity function associated with said leaf-level entity.

13. The system as claimed in claim 12, wherein said means for computing of said entity-instance assessment further comprises:
means for obtaining of a plurality of non-leaf-level entities of said hierarchy;
means for computing of a plurality of non-leaf-level entity values associated with said plurality of non-leaf-entities;
means for obtaining of an non-leaf-level entity of said plurality of non-leaf-level entities;
means for obtaining of a plurality of parameters associated with non-leaf-level entity;
means for computing of a plurality of parameter values based on said plurality of parameters;
means for obtaining of a plurality of sub-entities associated with said non-leaf-level entity based on said hierarchy;
means for determining of a plurality of sub-entity values based on said plurality of sub-entities;
means for obtaining of a non-leaf-level-entity function associated with said non-leaf-level-entity;
means for computing of a non-leaf-level-entity value based on said non-leaf-level-entity function, said plurality of sub-entity values, and said plurality of parameter values;
means for making of said non-leaf-level-entity value a part of said plurality of non-leaf-level entity values;
means for determining of a root-level entity value based on said plurality of non-leaf-level entity values;
means for determining of said entity-instance assessment based on said root-level entity value; and
means for assigning of said entity-instance assessment to said node.

14. The system as claimed in claim 1, wherein said means for computing of said entity assessment further comprises:
means for obtaining of said entity;
means for determining of a plurality entity-instances of said entity based on said university database and said university knowledgebase;
means for computing of a plurality of entity-instance values based on said plurality of entity-instances;
means for computing of said entity assessment based on said plurality of entity-instance values;
means for obtaining of an abstract node of said plurality of abstract nodes, wherein said abstract node is associated with said entity; and
means for assigning of said entity assessment to said abstract node.

15. The system as claimed in claim 1, wherein said means for obtaining of said plurality of influencers further comprises:
means for obtaining of a pair of entities of said plurality of pair of entities;
means for obtaining of an entity 1 of said pair of entities;
means for obtaining of an entity 2 of said pair of entities;
means for obtaining of a plurality of positive influencers of said plurality of influencers, wherein a positive influencer of said plurality of positive influencers has a positive impact on the relationship between an instance of said entity 1 and an instance of said entity 2;
means for obtaining of a plurality of negative influencers of said plurality of influencers, wherein a negative influencer of said plurality of negative influencers has a negative impact on the relationship between an instance of said entity 1 and an instance of said entity 2;
means for obtaining a plurality of paired positive perspectives of said plurality of influencers with respect to said pair entities, wherein a paired positive perspective of said plurality of paired positive perspectives comprises a positive perspective 1 with respect to said entity 1 and a positive perspective 2 with respect to said entity 2, and said positive perspective 1 provides the quantum of positive influence of a positive influencer of said plurality of positive influencers with respect to said entity 1, and said positive perspective 2 provides the quantum of positive influence of said positive influencer of said plurality of positive influencers with respect to said entity 2;
means for obtaining a plurality of paired negative perspectives of said plurality of influencers with respect to said pair entities, wherein a paired negative perspective of said plurality of paired negative perspectives comprises a negative perspective 1 with respect to said entity 1 and a negative perspective 2 with respect to said entity 2, and said negative perspective 1 provides the quantum of negative influence of a negative influencer of said plurality of negative influencers with respect to said entity 1, and said negative perspective 2 provides the quantum of negative influence of said negative influencer of said plurality of negative influencers with respect to said entity 2;
means for obtaining of a plurality of influencing parameters 1 associated with said entity 1 of said pair of entities; and
means for obtaining of a plurality of influencing parameters 2 associated with said entity 2 of said pair of entities.

16. The system as claimed in claim 1, wherein said means of computing said influence value further comprises:
means for obtaining of said source entity-instance;
means for obtaining of said destination entity-instance;
means for determining of a source entity of said plurality of entities associated with source entity-instance;
means for determining of a destination entity of said plurality of entities associated with said destination entity-instance;
means for determining of a plurality of entity pair influencers based on said plurality of influencers;
means for determining of a plurality of entity pair positive influencers based on said plurality of entity pair influencers;
means for determining of a plurality of entity pair negative influencers based on said plurality of entity pair influencers;
means for determining of a plurality of entity pair positive perspectives based on said plurality of entity pair influencers;
means for determining of a plurality of entity pair negative perspectives based on said plurality of entity pair influencers;
means for determining of a plurality of correlated transactions based on said source entity-instance, said destination entity-instance, said university database, and said university knowledgebase;
means for computing of a plurality of pn values based on said source entity, said plurality of entity pair positive influencers, said plurality of entity pair negative influencers, said plurality of entity pair positive perspectives, and said plurality of entity pair negative perspective, and said plurality of correlated transactions;
means for computing of an influence component 1 based on said plurality of pn values and a pre-defined function;
means for determining of a plurality of entity-instance assessments based on said plurality of assessments, said entity-instance, and a pre-defined interval of time;
means for computing of an influence component 2 based on said plurality of entity-instance assessments and a pre-defined function;
means for determining of a plurality of influencing parameters associated with said source entity based on said plurality of influencers;
means for computing of an influence component 3 based on said plurality of influencing parameters, said university database, said university knowledgebase, and a pre-defined function; and
means for computing of said influence value associated with said source entity-instance and said destination entity-instance based on said influence component 1, said influence component 2, said influence component 3, and a pre-defined function.

17. The system as claimed in claim 16, wherein said means for computing of said plurality of pn values further comprises:
means for determining a positive influencer based on said plurality of entity pair positive influencers;
means for determining of a positive perspective based on said source entity, said positive influencer, and said plurality of entity pair positive perspectives;
means for computing of a positive influence value based on said source entity-instance, said positive influencer, a rule condition associated with said positive influencer, said plurality of correlated transactions, and said positive perspective;
means for making of said positive influence value a part of said plurality of pn values;
means for determining a negative influencer based on said plurality of entity pair negative influencers;
means for determining of a negative perspective based on said source entity, said negative influencer, and said plurality of entity pair negative perspectives;
means for computing of a negative influence value based on said source entity-instance, said negative influencer, a rule condition associated with said negative influencer, said plurality of correlated transactions, and said negative perspective; and
means for making of said negative influence value a part of said plurality of pn values.

18. The system as claimed in claim 1, wherein said means for computing of an entity influence value further comprises:
means for computing of a plurality of instance entity influence values based on said source entity and said destination entity; and
means for computing of said entity influence value based on said plurality of instance entity influence values;

19. The system as claimed in claim 18, wherein said means for computing of an instance entity influence value of said plurality of instance entity values further comprises:
means for determining of a plurality of source entity-instances of said plurality of entity-instances, wherein each of said plurality source entity-instances is associated with said source entity;
means for determining of a plurality of destination entity-instances of said plurality of entity-instances, wherein each of said plurality of destination entity-instances is associated with said destination entity;
means for determining of a source entity-instance of said plurality of source entity-instances;
means for determining of a plurality of influenced entity-instances based on said plurality of destination entity-instances, wherein the influence value associated between said source entity-instance and each of said plurality of influenced entity-instances exceeds a pre-defined threshold;
means for determining of a plurality of source influence values based on said source entity-instance and said plurality of influenced entity-instances, wherein a source influence value of said plurality of source influence values is an influence value associated with said source entity-instance and an influenced entity-instance of said plurality of influenced entity-instances;
means for determining of a plurality of positive source influence values based on said plurality of source influence values, wherein each of said positive source influence values>0.0;
means for determining of a plurality of negative source influence values based on said plurality of source influence values, wherein each of said negative source influence values<0.0;
means for computing of a plurality of positive clusters based on said plurality of positive source influence values;
means for computing of a plurality of negative clusters based on said plurality of negative source influence values;
means for selecting of a plurality of selected positive clusters based on said plurality of positive clusters, wherein population of each of said plurality of selected positive clusters exceeds a pre-defined threshold;
means for selecting of a plurality of selected negative clusters based on said plurality of negative clusters, wherein population of each of said plurality of selected negative clusters exceeds a pre-defined threshold;
means for computing of a total population size based on said plurality of selected positive clusters and said plurality of selected negative clusters;
means for selecting a plurality of selected top positive clusters based on said plurality of selected positive clusters, wherein size of said plurality of selected top positive clusters exceeds a pre-defined threshold based on said total population size;
means for selecting a plurality of selected top negative clusters based on said plurality of selected negative clusters, wherein size of said plurality of selected top negative clusters exceeds a pre-defined threshold based on said total population size;
means for computing of a plurality of centroids based on said plurality of selected top positive clusters and said plurality of selected top negative clusters;
means for computing of a plurality of weights based on size of each of said plurality of selected top positive clusters and size of each of said plurality of selected top negative clusters;
means for computing of said instance entity influence value based on said plurality of centroids and said plurality of weights;

20. The system as claimed in claim 18, wherein said means for computing of said entity influence value further comprises:
means for obtaining of said plurality of instance entity influence values;
means for determining of a plurality of positive source influence values based on said plurality of instance entity influence values, wherein each of said positive source influence values>0.0;
means for determining of a plurality of negative source influence values based on said plurality of instance entity influence values, wherein each of said negative source influence values<0.0;
means for computing of a plurality of positive clusters based on said plurality of positive source influence values;
means for computing of a plurality of negative clusters based on said plurality of negative source influence values;
means for selecting of a plurality of selected positive clusters based on said plurality of positive clusters, wherein population of each of said plurality of selected positive clusters exceeds a pre-defined threshold;
means for selecting of a plurality of selected negative clusters based on said plurality of negative clusters, wherein population of each of said plurality of selected negative clusters exceeds a pre-defined threshold;
means for computing of a total population size based on said plurality of selected positive clusters and said plurality of selected negative clusters;
means for selecting a plurality of selected top positive clusters based on said plurality of selected positive clusters, wherein size of said plurality of selected top positive clusters exceeds a pre-defined threshold based on said total population size;
means for selecting a plurality of selected top negative clusters based on said plurality of selected negative clusters, wherein size of said plurality of selected top negative clusters exceeds a pre-defined threshold based on said total population size;
means for computing of a plurality of centroids based on said plurality of selected top positive clusters and said plurality of selected top negative clusters;
means for computing of a plurality of weights based on size of each of said plurality of selected top positive clusters and size of each of said plurality of selected top negative clusters;
means for computing of said entity influence value based on said plurality of centroids and said plurality of weights;

21. The system as claimed in claim 1, wherein said means for computing of said entity-instance-entity-influence value further comprises:
means for obtaining of said source entity-instance;
means for determining of a plurality of destination entity-instances, wherein each of said plurality of destination entity-instances is associated with said destination entity;
means for determining of a plurality of influenced entity-instances based on said plurality of destination entity-instances, wherein the influence value associated between said source entity-instance and each of said plurality of influenced entity-instances exceeds a pre-defined threshold;
means for determining of a plurality of source influence values based on said source entity-instance and said plurality of influenced entity-instances, wherein a source influence value of said plurality of source influence values is an influence value associated with said source entity-instance and an influenced entity-instance of said plurality of influenced entity-instances;
means for determining of a plurality of positive source influence values based on said plurality of source influence values, wherein each of said positive source influence values>0.0;
means for determining of a plurality of negative source influence values based on said plurality of source influence values, wherein each of said negative source influence values<0.0;
means for computing of a plurality of positive clusters based on said plurality of positive source influence values;
means for computing of a plurality of negative clusters based on said plurality of negative source influence values;
means for selecting of a plurality of selected positive clusters based on said plurality of positive clusters, wherein population of each of said plurality of selected positive clusters exceeds a pre-defined threshold;
means for selecting of a plurality of selected negative clusters based on said plurality of negative clusters, wherein population of each of said plurality of selected negative clusters exceeds a pre-defined threshold;
means for computing of a total population size based on said plurality of selected positive clusters and said plurality of selected negative clusters;
means for selecting a plurality of selected top positive clusters based on said plurality of selected positive clusters, wherein size of said plurality of selected top positive clusters exceeds a pre-defined threshold based on said total population size;
means for selecting a plurality of selected top negative clusters based on said plurality of selected negative clusters, wherein size of said plurality of selected top negative clusters exceeds a pre-defined threshold based on said total population size;
means for computing of a plurality of centroids based on said plurality of selected top positive clusters and said plurality of selected top negative clusters;
means for computing of a plurality of weights based on size of each of said plurality of selected top positive clusters and size of each of said plurality of selected top negative clusters; and
means for computing of said entity-instance-entity-influence value based on said plurality of centroids and said plurality of weights.

22. The system as claimed in claim 1, wherein said means for computing of said entity-entity-instance-influence value further comprises:
means for obtaining of said source entity;
means for obtaining of said destination entity-instance;
means for determining of a plurality of source entity-instances, wherein each of said plurality of source entity-instances is associated with said source entity;
means for determining of a plurality of influencing entity instances based on said plurality of source entity-instances and said destination entity-instance, wherein the influence value associated between said source entity-instance and each of said plurality of influencing entity-instances exceeds a pre-defined threshold;
means for determining of a plurality of source influence values based on said destination entity-instance and said plurality of influenced entity-instances, wherein a source influence value of said plurality of source influence values is an influence value associated with said destination entity-instance and an influenced entity-instance of said plurality of influenced entity-instances;
means for determining of a plurality of positive source influence values based on said plurality of source influence values, wherein each of said positive source influence values>0.0;
means for determining of a plurality of negative source influence values based on said plurality of source influence values, wherein each of said negative source influence values<0.0;
means for computing of a plurality of positive clusters based on said plurality of positive source influence values;
means for computing of a plurality of negative clusters based on said plurality of negative source influence values;
means for selecting of a plurality of selected positive clusters based on said plurality of positive clusters, wherein population of each of said plurality of selected positive clusters exceeds a pre-defined threshold;
means for selecting of a plurality of selected negative clusters based on said plurality of negative clusters, wherein population of each of said plurality of selected negative clusters exceeds a pre-defined threshold;
means for computing of a total population size based on said plurality of selected positive clusters and said plurality of selected negative clusters;
means for selecting a plurality of selected top positive clusters based on said plurality of selected positive clusters, wherein size of said plurality of selected top positive clusters exceeds a pre-defined threshold based on said total population size;
means for selecting a plurality of selected top negative clusters based on said plurality of selected negative clusters, wherein size of said plurality of selected top negative clusters exceeds a pre-defined threshold based on said total population size;
means for computing of a plurality of centroids based on said plurality of selected top positive clusters and said plurality of selected top negative clusters;
means for computing of a plurality of weights based on size of each of said plurality of selected top positive clusters and size of each of said plurality of selected top negative clusters; and
means for computing of said entity-entity-instance-influence value based on said plurality of centroids and said plurality of weights.
